(19) United States
(12) Patent Application Publication
(10) Pub. No.: US 2023/0180273 A1
(43) Pub. Date: Jun. 8, 2023

(54) METHOD AND APPARATUS FOR TRANSMISSION AND RECEPTION OF SIGNAL AND COMMUNICATION SYSTEM

(71) Applicant: FUJITSU LIMITED, Kawasaki-shi (JP)

(72) Inventors: Yang Lu, Beijing (CN); Guorong Li, Beijing (CN); Meiyi Jia, Beijing (CN)

(73) Assignee: FUJITSU LIMITED, Kawasaki-shi (JP)

(21) Appl. No.: 18/104,552

(22) Filed: Feb. 1, 2023

Related U.S. Application Data
(63) Continuation of application No. PCT/CN2020/107586, filed on Aug. 6, 2020.

(51) Int. Cl. H04W 72/51; H04W 74/08

(52) U.S. Cl. CPC H04W 72/51; H04W 74/0833

(57) ABSTRACT

A method and apparatus for transmission and reception of a signal and a communication system. The apparatus for transmission and reception of a signal is configured to: transmit first random access configuration information used for an unconventional terminal and second random access configuration information used for a conventional terminal; receive a message transmitted by the unconventional terminal according to the first random access configuration; and perform data transmission with the unconventional terminal by using an unconventional transmission mode.

### CROSS-REFERENCE TO RELATED APPLICATION

This application is a continuation application of International Application PCT/CN2020/107586 filed on Aug. 6, 2020 and designated the U.S., the entire contents of which are incorporated herein by reference.

### TECHNICAL FIELD

This disclosure relates to the field of wireless communication technologies.

### BACKGROUND

In 5G application scenarios, in addition to the application of high-performance terminal equipments such as ultra-high reliability and low latency communication (URLLC) terminals, terminal equipments with medium and low capabilities are often used.

For example, in an application scenario of a large-scale industrial wireless sensor network (IWSN), a terminal equipment with a medium and low capability includes a temperature and humidity sensor, a pressure sensor, an accelerator, and a motion sensor, etc.; for another example, in an application scenario of a smart city, widely deployed video surveillance cameras also belong to terminal equipments with medium and low capabilities; and for a further example, a large number of wearable devices, such as smart watches, bracelets, wearable medical monitoring devices, are also terminal equipments with low and medium capabilities. However, the existing 3GPP standards have relatively high requirements on complexities and processing capabilities of 5G terminal equipments, and are unable to well support such terminal equipments with lower capabilities, resulting in relatively high cost of existing terminal equipments, and limiting widespread deployment and application of 5G. In order to support low-cost terminal equipments with low and medium capabilities, 3GPP started a research project on supporting terminal equipments with low and medium capabilities in Release 17 (Rel-17).

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY OF THE DISCLOSURE

Performances of the above terminal equipments with medium and low capabilities needing to be widely used are lower than those of the existing 5G New Radio (NR) terminal equipments of the 3rd Generation Partnership Project (3GPP) (such as those terminal equipments supported by Release 15 (Rel-15) or Release 16 (Rel-16)), but are higher than those of terminal equipments with low capabilities supported by the existing Low Power Wide Area Network (LPWA), the Low Power Wide Area Network being, for example, a narrowband Internet of Things (NB IoT), or a long-term evolution machine to machine (LTE-M) network.

Compared with the existing 5G terminal equipments, such as 3GPP Rel-16 Enhanced Mobile Broadband (eMBB) equipments and Ultra High Reliability and Low Latency Communication (URLLC) equipments, these terminal equipments with medium and low capabilities have at least lower complexities and lower processing capabilities compared with the existing 5G terminal equipments.

It was found by the inventors of this disclosure that existing Rel-15 and Rel-16 communication systems have relatively high requirements on complexities and processing capabilities of 5G terminal equipments, and are unable to well support the above terminal equipments with medium and low capabilities, including being unable to transmit data in a manner matching the lower complexities and lower performances of the above terminal equipments with medium and low capabilities, resulting in relatively high cost of terminal equipments, and limiting widespread deployment and application of 5G.

In this description, the terminal equipments supported by Rel-15 and Rel-16 communication systems are also referred to as conventional terminals, and the above terminal equipments with medium and low capabilities are also referred to as unconventional terminals.

Embodiments of this disclosure provide a method and apparatus for transmission and reception of a signal and a communication system, in which a network device transmits to a terminal equipment first random access configuration information used for an unconventional terminal and second random access configuration information used for a conventional terminal, receives a message transmitted by the unconventional terminal according to first random access configuration, and then performs data transmission with the unconventional terminal by using an unconventional transmission mode. Hence, the network device is able to perform differentiated configuration and processing on the conventional terminal and the unconventional terminal during the random access procedure based on the low performance of the unconventional terminal, so that a terminal is able to perform random access with the configuration matching its performance, and is able to subsequently transmit data with an unconventional terminal in a manner matching the performance of the unconventional terminal, thereby making the system able to support the unconventional terminal equipment in the whole communication process, and lowering application cost of the 5G system.

According to a first aspect of the embodiments of this disclosure, there is provided a method for transmission and reception of a signal, applicable to a network device, the method including:
transmitting first random access configuration information used for an unconventional terminal and second random access configuration information used for a conventional terminal;
receiving a message transmitted by the unconventional terminal according to first random access configuration; and
performing data transmission with the unconventional terminal by using an unconventional transmission mode.

According to a second aspect of the embodiments of this disclosure, there is provided a method for transmission and reception of a signal, applicable to a network device, the method including:
receiving unconventional capability indication information transmitted by an unconventional terminal on a physical uplink shared channel (PUSCH); and
performing data transmission with the unconventional terminal by using an unconventional transmission mode.

According to a third aspect of the embodiments of this disclosure, there is provided a method for transmission and reception of a signal, applicable to a terminal equipment, the method including:
receiving first random access configuration information, transmitted by a network device, used for an unconventional terminal;
transmitting a message to the network device according to the first random access configuration information; and
performing data transmission with the network device by using an unconventional transmission mode.

According to a fourth aspect of the embodiments of this disclosure, there is provided a method for transmission and reception of a signal, applicable to a terminal equipment, the method including:
transmitting unconventional capability indication information to a network device via a physical uplink shared channel (PUSCH); and
performing data transmission with the network device by using an unconventional transmission mode.

According to a fifth aspect of the embodiments of this disclosure, there is provided an apparatus for transmission and reception of a signal, applicable to a network device, the apparatus executing the method for transmission and reception of a signal as described in the first or second aspect of the embodiments of this disclosure.

According to a sixth aspect of the embodiments of this disclosure, there is provided an apparatus for transmission and reception of a signal, applicable to a terminal equipment, the apparatus executing the method for transmission and reception of a signal as described in the third or fourth aspect of the embodiments of this disclosure.

According to a seventh aspect of the embodiments of this disclosure, there is provided a network device, including the apparatus as described in the fifth aspect of the embodiments of this disclosure.

According to an eighth aspect of the embodiments of this disclosure, there is provided a terminal equipment, including the apparatus as described in the sixth aspect of the embodiments of this disclosure.

According to a ninth aspect of the embodiments of this disclosure, there is provided a communication system, including the terminal equipment as described in the eighth aspect of the embodiments of this disclosure and the network device as described in the seventh aspect of the embodiments of this disclosure.

According to a tenth aspect of the embodiments of this disclosure, there is provided a computer readable program, which, when executed in an apparatus for transmission and reception of a signal or a terminal equipment, will cause the apparatus for transmission and reception of a signal or the terminal equipment to carry out the method for transmission and reception of a signal as described in the third or fourth aspect of the embodiments of this disclosure.

According to an eleventh aspect of the embodiments of this disclosure, there is provided a computer storage medium, including a computer readable program, which will cause an apparatus for transmission and reception of a signal or a terminal equipment to carry out the method for transmission and reception of a signal as described in the third or fourth aspect of the embodiments of this disclosure.

According to a twelfth aspect of the embodiments of this disclosure, there is provided a computer readable program, which, when executed in an apparatus for transmission and reception of a signal or a network device, will cause the apparatus for transmission and reception of a signal or the network device to carry out the method for transmission and reception of a signal as described in the first or second aspect of the embodiments of this disclosure.

According to a thirteenth aspect of the embodiments of this disclosure, there is provided a computer storage medium, including a computer readable program, which will cause an apparatus for transmission and reception of a signal or a network device to carry out the method for transmission and reception of a signal as described in the first or second aspect of the embodiments of this disclosure.

An advantage of the embodiments of this disclosure exists in that the network device is able to perform differentiated configuration and processing on the conventional terminal and the unconventional terminal during the random access procedure based on the low performance of the unconventional terminal, so that a terminal is able to perform random access with the configuration matching its performance, and is able to subsequently transmit data with an unconventional terminal in a manner matching the performance of the unconventional terminal, thereby making the system able to support the unconventional terminal equipment in the whole communication process, and lowering application cost of the 5G system.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a communication system of an embodiment of this disclosure;

FIG. 2A is a flowchart of an existing 4-step contention-based random access procedure;

FIG. 2B is a flowchart of an existing 2-step contention-based random access procedure;

FIG. 3 is a schematic diagram of the method for transmission and reception of a signal of the first aspect of the embodiments of this disclosure;

FIG. 3A is another schematic diagram of the method for transmission and reception of a signal of the first aspect of the embodiments of this disclosure;

FIG. 4 is a schematic diagram of an RAR transmitted by a network device to a terminal;

FIG. 5 is a schematic diagram of an RAR or fallbackRAR transmitted by the network device to the terminal;

FIG. 6 is a schematic diagram of successRAR of the MsgB transmitted by the network device to the terminal;

FIG. 7 is a schematic diagram of the method for transmission and reception of a signal of the second aspect of the embodiments of this disclosure;

FIG. 7A is another schematic diagram of the method for transmission and reception of a signal of the second aspect of the embodiments of this disclosure;

FIG. 8 is a schematic diagram of an RAR or fallbackRAR transmitted by the network device to the terminal;

FIG. 9 is a schematic diagram of the method for transmission and reception of a signal of the third aspect of the embodiments of this disclosure;

FIG. 9A is another schematic diagram of the method for transmission and reception of a signal of the third aspect of the embodiments of this disclosure;

FIG. 10 is a schematic diagram of the method for transmission and reception of a signal of the fourth aspect of the embodiments of this disclosure;

FIG. 10A is another schematic diagram of the method for transmission and reception of a signal of the fourth aspect of the embodiments of this disclosure;

FIG. 11 is a schematic diagram of the apparatus for transmission and reception of a signal of the fifth aspect of the embodiments of this disclosure;

FIG. 12 is a schematic diagram of the apparatus for transmission and reception of a signal of the sixth aspect of the embodiments of this disclosure;

FIG. 13 is a schematic diagram of a structure of a network device of the seventh aspect of the embodiments of this disclosure; and

FIG. 14 is a block diagram of a systematic structure of a terminal equipment of the eighth aspect of the embodiments of this disclosure.

### DETAILED DESCRIPTION OF THE DISCLOSURE

These and further aspects and features of this disclosure will be apparent with reference to the following description and attached drawings. In the description and drawings, particular embodiments have been disclosed in detail as being indicative of some of the ways in which the principles of certain embodiments may be employed, but it is understood that the invention is not limited correspondingly in scope. Rather, the invention includes all changes, modifications and equivalents coming within the terms of the appended claims. Various implementations of this disclosure shall be described below with reference to the accompanying drawings. These implementations are illustrative only, and are not intended to limit this disclosure.

In the embodiments of this disclosure, terms “first,” and “second,” etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain,” “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE)” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The user equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Scenarios of the embodiments of this disclosure shall be described below by way of examples; however, this disclosure is not limited thereto.

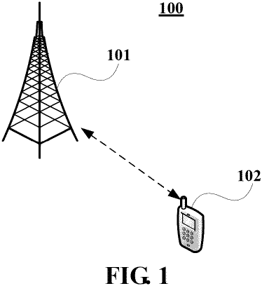

FIG. 1 is a schematic diagram of a communication system of an embodiment of this disclosure, in which a case where a terminal equipment and a network device are taken as examples is schematically shown. As shown in FIG. 1, a communication system 100 may include a network device 101 and a terminal equipment 102 (for the sake of simplicity, an example having only one terminal equipment is schematically given in FIG. 1).

In the embodiment of this disclosure, existing traffics or traffics that may be implemented in the future may be performed between the network device 101 and the terminal equipment 102. For example, such traffics may include but not limited to enhanced mobile broadband (eMBB), massive machine type communication (MTC), and ultra-reliable and low-latency communication (URLLC).

The terminal equipment 102 may transmit data to the network device 101, for example, in a grant-free transmission mode. The network device 101 may receive data transmitted by one or more terminal equipments 102, and feed back information (such as acknowledgement ACK/non-acknowledgement NACK) to the terminal equipment 102, and the terminal equipment 102 may acknowledge terminating a transmission process according to the feedback information, or may further perform new data transmission, or may perform data retransmission.

In the following embodiments, the terminal equipment 102 establishes a communication connection to the network device 101 through a random access procedure. The random access process is, for example, a four-step random access procedure or a two-step random access procedure.

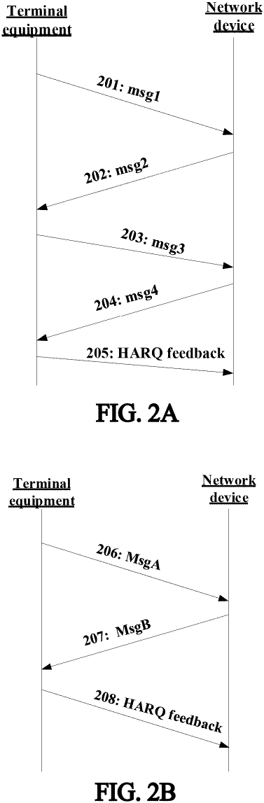

FIG. 2A is a flowchart of a 4-step contention-based random access (CBRA) procedure. As shown in FIG. 2A, in step 201, the terminal equipment 102 selects a CBRA preamble, and transmits the preamble via msg1 in a contention-based random access occasion (RO) preconfigured by a system; in step 202, the network device 101 transmits msg2 after receiving the preamble; hence, a random access response (RAR) grants a dedicated uplink PUSCH resource for the terminal equipment 102 transmitting the preamble and allocates a temporary cell radio network temporary identifier indicating uplink advance of a physical uplink shared channel (PUSCH); in step 203, the terminal equipment 102 transmits msg3 carrying signaling or data on the PUSCH resource; in step 204, the network device 101 transmits to the terminal equipment 102 contention resolution signaling msg4 for msg3; and in step 205, the terminal equipment 102 performs hybrid automatic repeat request (HARQ) feedback on msg4 via a physical uplink control channel (PUCCH).

FIG. 2B is a flowchart of a 2-step contention-based random access procedure. As shown in FIG. 2B, in step 206, the terminal equipment 102 transmits MsgA, which includes a CBRA preamble and payload, and the terminal equipment 102 transmits the preamble of MsgA on the contention-based RO and transmits the signaling or service data of MsgA on the contention-based physical uplink shared channel (PUSCH) resource; in step 207, the network device transmits MsgB after receiving MsgA, thereby transmitting to the terminal equipment a random access response and contention resolution message; and in step 208, the terminal equipment 102 performs hybrid automatic repeat request (HARQ) feedback on MsgA via the physical uplink control channel (PUCCH).

In the following embodiments of this disclosure, the first message may be msg1, the second message may be MsgA, the third message may be msg3, the fourth message may be msg4, and the fifth message may be MsgB.

In addition, in the following embodiments, the terminal equipment 102 may also establish communication connection with the network device 101 via a contention-free random access procedure.

In the following embodiments of this disclosure, the terminal equipment 102 may be a conventional terminal, or may also be an unconventional terminal (RedCap), wherein the conventional terminal refers to a terminal equipment supported by Release 15 (Rel-15) or Release 16 (Rel-16) of the 3rd Generation Partnership Project (3GPP); and compared with the conventional terminal, the unconventional terminal has a lower complexity and lower processing capability. In addition, performances of the unconventional terminal are higher than those of a terminal equipment supported by a low-power wide-area network (LPWA).

### First Aspect of Embodiments

The first aspect of embodiments of this disclosure relates to a method for transmission and reception of a signal, applicable to a network device, such as the network device 101.

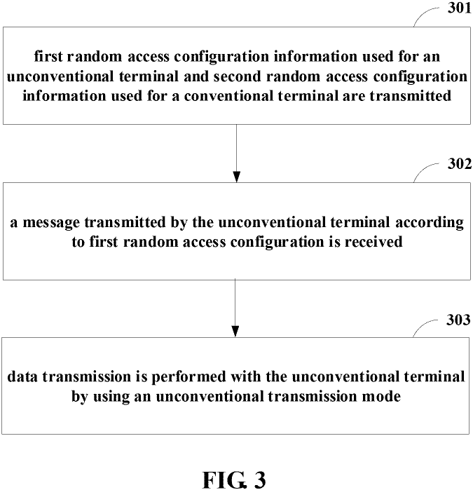

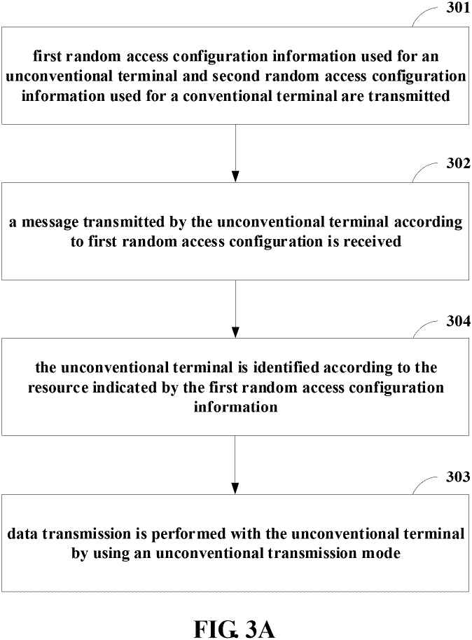

FIG. 3 is a schematic diagram of the method for transmission and reception of a signal of the first aspect of the embodiments of this disclosure. As shown in FIG. 3, the method for transmission and reception of a signal may include:
operation 301: first random access configuration information used for an unconventional terminal and second random access configuration information used for a conventional terminal are transmitted;
operation 302: a message transmitted by the unconventional terminal according to first random access configuration is received; and
operation 303: data transmission is performed with the unconventional terminal by using an unconventional transmission mode.

Due to a limited processing capability of the unconventional terminal, the random access configuration of network device for the unconventional terminal may need to be lower than that of the conventional terminal, whereby the network device is able to support the unconventional terminal better. In operation 301, the network device 101 may transmit both of the first random access configuration information and the second random access configuration information to the unconventional terminal and the conventional terminal by broadcast. Thus, the unconventional terminal may transmit information to the network device 101 in the first random access configuration when receiving the first random access configuration information and the second random access configuration information. In addition, the conventional terminal may transmit information to the network device in second random access configuration when receiving the first random access configuration information and the second random access configuration information.

According to the first aspect of the embodiments of this disclosure, the network device transmits to the terminal equipment the first random access configuration information used for the unconventional terminal and the second random access configuration information used for the conventional terminal, and receives the message transmitted by the unconventional terminal in the first random access configuration, and then the network device performs data transmission with the unconventional terminal in the unconventional transmission mode. Therefore, the network device is able to perform differentiated configuration and processing on the conventional terminal and the unconventional terminal during the random access procedure based on the relatively low performance of the unconventional terminal, so that the terminal is able to perform random access with the configuration matching its performance, and is able to subsequently perform data transmission with the unconventional terminal in a manner matching the performance of the unconventional terminal, so that the system is able to support the unconventional terminal equipment in the whole communication process, thereby lowering application cost of a 5G system.

FIG. 3A is another schematic diagram of the method for transmission and reception of a signal of the first aspect of the embodiments of this disclosure. As shown in FIG. 3A, before operation 303, the method may further include:

operation 304: the unconventional terminal is identified according to the resource indicated by the first random access configuration information.

A resource location under the first random access configuration used by the unconventional terminal may be different from a location of a second random access resource used by the conventional terminal. Therefore, in operation 304, the network device 101 may identify the unconventional terminal according to the random access resource used by the unconventional terminal in transmitting a random access message. Operation 304 may be after operation 302.

Compared with the conventional terminal, the unconventional terminal has a lower complexity and lower processing capability, which are mainly reflected in the following aspects: a reduced number of receiving and transmitting antennas of the equipment, a reduced transmission bandwidth, frequency division duplex (FDD) supporting only half duplex, longer data processing time, and lower data processing capability, etc. In at least one embodiment, the unconventional transmission mode in operation 303 includes at least one of the following: a transmission bandwidth is lower than a bandwidth supported by the conventional terminal, the number of antennas is less than the number of antennas supported by the conventional terminal, the number of HARQ processes is less than the number of HARQ processes supported by the conventional terminal, a modulation and coding scheme is lower than a modulation and coding scheme supported by the conventional terminal, a half duplex frequency division duplex mode, or a transport block size is smaller than that supported by the conventional terminal. Operation 303 may be after operation 302, that is, after the message transmitted by the unconventional terminal in the first random access configuration is received in operation 302, data transmission with the unconventional terminal is performed in a transmission mode lower than that of the conventional terminal in operation 303.

In at least one embodiment, the first random access configuration includes at least one of the following configurations: random access channel (RACH) configuration of a first message (msg 1); physical uplink shared channel (PUSCH) configuration of a third message (msg 3); random access channel (RACH) configuration of a second message (Msg A) in two-step random access; PUSCH configuration of the second message (Msg A); physical uplink control channel (PUCCH) configuration performing HARQ feedback on a fourth message (msg 4); or physical uplink control channel (PUCCH) configuration performing HARQ feedback on a fifth message (Msg B).

As the processing capability of the unconventional terminal is limited, the unconventional terminal may possibly not support a large msg1 subcarrier spacing (such as 240 Hz), not support a larger msg3 or MsgA transmission bandwidth (such as not supporting bandwidths greater than 20 MHz), and msg3 or MsgA may possibly not support a larger modulation coding scheme (such as not supporting modulation coding schemes higher than 64QAM). The random access configuration of the network device on the unconventional terminal is different from that on the conventional terminal, which may be reflected in random access channel (RACH) configurations of the first message (msg1), such as including resource configuration of a random access occasion (RO) of msg1, and subcarrier spacing configuration of a preamble of msg1; physical random access channel (PRACH) configurations of MsgA are different, such as including configuration of the random access occasion (RO) of MsgA, and subcarrier spacing configuration of the MsgA preamble; PUSCH configurations of msg3 are different, such as a size and location configuration of the PUSCH time-frequency domain resource of msg3, and a modulation and coding scheme of msg3; PUSCH configurations of MsgA are different, including a size and location configuration of the time-frequency domain resource of the MsgA PUSCH, and a modulation and coding scheme, etc; or, PUCCH configurations for HARQ feedback of msg4 or MsgB are different, including configurations of PUCCH resources, PUCCH signal processing modes, etc.

The method for transmission and reception of a signal of FIG. 3 or FIG. 3A shall be described below by way of different embodiments.

### Embodiment 1

In Embodiment 1, the random access configuration may be: RACH configuration of a first message (msg 1), or RACH configuration of a second message (Msg A) in two-step random access, or PUSCH configuration of the second message (Msg A). For example, the network device 101 transmits RACH configuration of random access to the terminal equipment 102, and receives preamble of the first message msg1 or the second message MsgA transmitted by the terminal equipment 102 in the RACH configuration.

Embodiment 1 may be implemented in multiple ways.

### Method 1

In method 1, operation 301 includes: first system information (SI) for an unconventional terminal and second system information (SI) for a conventional terminal are transmitted.

According to contents of the first system information and the second system information, two cases may exist in method 1.

### A First Case of Method 1

The first system information may include a first master information block (MIB) and a first system information block 1 (SIB1), the first master information block containing configuration information used for scheduling a physical downlink control channel (PDCCH) of the first system information block 1. Thus, the unconventional terminal may receive the PDCCH according to the configuration information of the PDCCH, and then receive the first system information block 1 according to the received PDCCH.

The PRACH configuration information of msg1 or MsgA for performing random access by the unconventional terminal is, for example, included in configuration information of an uplink common bandwidth part (BWP) in the first system information block 1 (SIB1).

In addition, the first master information block may further contain an unconventional identifier. The unconventional identifier is used to indicate that the first master information block contains the configuration information used for scheduling the physical downlink control channel (PDCCH) of the first system information block 1.

For example, the contents of the first master information block may be as shown in Table 1 below.

TABLE 1

| | |
|---|---|
| MIB ::= | SEQUENCE { |
| systemFrameNumber | BIT STRING (SIZE (6)), |
| subCarrierSpacingCommon | ENUMERATED {scs15or60, scs30orl20}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |

The second system information may include a second master information block and a second system information block 1, the second master information block containing configuration information used for receiving a PDCCH of the second system information block 1. Thus, the conventional terminal may receive the PDCCH according to the configuration information of the PDCCH, and then receive the second system information block 1 according to the received PDCCH.

### A Second Case of Method 1

The first system information includes a third master information block, a third system information block 1 (SIB1) and a fourth system information block 1 (SIB1), and the second system information includes the third master information block and the third system information block 1.

The third master information block contains configuration information used for receiving a PDCCH of the third system information block 1, and the third system information block 1 contains configuration information used for scheduling a PDCCH of the fourth system information block 1; the third system information block 1 contains random access configuration information used for the conventional terminal, and the fourth system information block 1 contains random access configuration information used for the unconventional terminal. For example, the PRACH configuration information of Msg1 or MsgA for performing random access by the unconventional terminal is included in configuration information of an uplink common bandwidth part (BWP) in the fourth system information block 1 (SIB1).

In the second case, the third master information block and the third system information block 1 are shared by the unconventional terminal and conventional terminal. That is, the conventional terminal receives the PDCCH according to the configuration information, included in the third master information block, used for scheduling the PDCCH of the third system information block 1, then receives the third system information block 1 according to the received PDCCH, determines the RACH configuration by using the RACH configuration information contained in the third system information block 1, and transmits the preamble of Msg1 or MsgA according to the RACH configuration; and the unconventional terminal receives PDCCH according to the configuration information, contained in the third master information block, used for receiving the PDCCH of the fourth system information block 1, then receives the fourth system information block 1 according to the received PDCCH, determines the RACH configuration by using the RACH configuration information contained in the fourth system information block 1, and transmits the preamble of Msg1 or MsgA according to the RACH configuration.

In method 1, the unconventional terminal and the conventional terminal use different system information, and the unconventional terminal does not need to receive the system information of the conventional terminal, which has lower requirements on the processing capability of the unconventional terminal, and is more conducive to power saving of the terminals.

### Method 2

In method 2, operation 301 includes: transmitting first uplink bandwidth part (BWP) configuration information used for the unconventional terminal and second uplink bandwidth part (BWP) configuration information used for the conventional terminal.

In method 2, the unconventional terminal and the conventional terminal may share MIB and SIB1; however, the first uplink bandwidth part (BWP) configuration information is different from the second uplink bandwidth part (BWP) configuration information.

In at least one implementation, the first uplink bandwidth part (BWP) configuration information and the second uplink bandwidth part (BWP) configuration information may be transmitted via the system information.

That is, the first uplink bandwidth part configuration information includes first initial uplink bandwidth part configuration information transmitted via the system information, wherein the first initial uplink bandwidth part configuration information includes common configuration of a first initial uplink bandwidth part. The second uplink bandwidth part configuration information includes second initial uplink bandwidth part configuration information transmitted via the system information, wherein the second initial uplink bandwidth part configuration information includes common configuration of a second initial uplink bandwidth part.

The common configuration of the first initial uplink bandwidth part includes first random access configuration information used for the unconventional terminal, and the common configuration of the second initial uplink bandwidth part includes second random access configuration information used for the conventional terminal.

The first initial uplink bandwidth part or the second initial uplink bandwidth part belongs to a normal uplink (NUL) carrier or a supplementary uplink (SUL) carrier of a serving cell.

A configuration parameter (initialUplinkBWPRedCap) of the first initial uplink bandwidth part is added to the uplink common configuration information (UplinkConfigCommon/supplementaryUplink) of the NUL carrier or SUL carrier in the common configuration of the serving cell and taken as the configuration information of the first initial uplink bandwidth part, which is, for example, as shown in Table 2 below.

TABLE 2

| | |
|---|---|
| ServingCellConfigCommonSIB ::= | SEQUENCE { |
| downlinkConfigCommon | DownlinkConfigCommonSIB, |
| uplinkConfigCommon | UplinkConfigCommonSIB |
| OPTIONAL, -- Need R | |
| supplementaryUplink | UplinkConfigCommonSIB |
| OPTIONAL, -- Need R | |
| n-TimingAdvanceOffset | ENUMERATED { n0, n25600, n39936 } |
| OPTIONAL, -- Need S | |
| ... | |
| } | |

The PRACH configuration information used for performing random access by the unconventional terminal may be included in the RACH common configuration information of the first initial uplink bandwidth part configuration information.

Parameters in the common configuration (BWP UplinkCommonRedCap) of the first initial uplink bandwidth part may be identical to those in the common configuration of the second initial uplink bandwidth part, or new parameters may not be included in the common configuration of the second initial uplink bandwidth part. The identical parameters may reuse the common configuration of the second initial uplink the bandwidth part, including basic parameters of the uplink BWP (including a frequency domain location and bandwidth of the BWP), common configuration of the random access channel (RACH), common configuration of a two-step random access RACH, MsgA PUSCH configuration, PUSCH common configuration or PUCCH common configuration, etc. Parameters that must be reused are not included in the common configuration of the first initial uplink bandwidth part.

When reusable and independently configurable parameters (i.e. first optional parameters) are included in the common configuration of the first initial uplink bandwidth part, an optional occurrence condition (Cond noRedCap) may be added to these parameters, indicating that these parameters are optional parameters (Need S) for the BWP of the unconventional terminal. If these parameters are present in the common configuration of the first initial uplink bandwidth part, contents of these parameters in the common configuration of the first initial uplink bandwidth part are used by the unconventional terminal. And if these parameters are not present in the common configuration of the first initial uplink bandwidth part, the unconventional terminal reuses contents of corresponding parameters in the common configuration of the second initial uplink bandwidth part.

For example, Table 3 and Table 4 below show an example of the common configuration of the first initial uplink bandwidth part.

TABLE 3

| | |
|---|---|
| BWP-UplinkCommonRedCap ::= | SEQUENCE { |
| genericParameters | BWP, OPTIONAL, |
| -- Cond noRedCap | |
| rach-ConfigCommon | SetupRelease { RACH-ConfigCommon } |
| OPTIONAL, -- Need M | |
| pusch-ConfigCommon | SetupRelease { PUSCH-ConfigCommon } |
| OPTIONAL, -- Need M | |
| pucch-ConfigCommon | SetupRelease { PUCCH-ConfigCommon } |
| OPTIONAL, -- Need M | |
| ..., | |
| [ [ | |
| rach-ConfigCommonIAB-r16 | SetupRelease { RACH-ConfigCommonIAB-r16 |
| } OPTIONAL, -- Need M | |
| useInterlacePUCCH-PUSCH-r16 | ENUMERATED {enabled} |
| OPTIONAL, -- Need M | |
| rach-ConfigCommonTwoStepRA-r16 | SetupRelease { |
| RACH-ConfigCommonTwoStepRA-r16 } | OPTIONAL, -- Need M |
| msgA-PUSCH-Config-r16 | SetupRelease { MsgA-PUSCH-Config-r16 } |
| OPTIONAL, -- Need M | |
| ] ] | |
| } | |
| BWP ::= | SEQUENCE { |
| locationAndBandwidth | INTEGER (0..37949), |
| subcarrierSpacing | SubcarrierSpacing, |
| cyclicPrefix | ENUMERATED { extended } |
| OPTIONAL-- NEED R | |

TABLE 4

| | |
|---|---|
| Conditional Presence | Explanation |
| noRedCap | The field is mandatory present for BWP except RedCap BWP. The field is optionally present for RedCap BWP, Need S, if the field is absent. |

In at least one other implementation, the first uplink partial bandwidth part (BWP) configuration information and the second uplink partial bandwidth part (BWP) configuration information may be transmitted via dedicated radio resource control (RRC) signaling.

That is, the first uplink bandwidth part configuration information includes at least one piece of first additional uplink bandwidth part configuration information transmitted via dedicated radio resource control (RRC) signaling, wherein the first additional uplink bandwidth part configuration information includes a BWP identifier of a first additional uplink bandwidth part, common configuration of the first additional uplink bandwidth part, and/or dedicated configuration of the first additional uplink bandwidth part. The common configuration of the first additional uplink bandwidth part includes first random access configuration information used for the unconventional terminal.

The first additional uplink bandwidth part may belong to the normal uplink (NUL) carrier or supplementary uplink (SUL) carrier of the serving cell. The first additional uplink bandwidth part is a BWP other than an initial BWP.

The second uplink bandwidth part configuration information includes at least one piece of second additional uplink bandwidth part configuration information transmitted via dedicated radio resource control (RRC) signaling, wherein the second additional uplink bandwidth part configuration information includes a BWP identifier of a second additional uplink bandwidth part, common configuration of the second additional uplink bandwidth part, and/or dedicated configuration of the second additional uplink bandwidth part.

The second additional uplink bandwidth part may belong to the normal uplink (NUL) carrier or supplementary uplink (SUL) carrier of the serving cell. The second additional uplink bandwidth part is a BWP other than the initial BWP.

Both of the first additional uplink bandwidth part configuration information and the second additional uplink bandwidth part configuration information may or may not exist.

In a specific implementation, for the first additional uplink bandwidth part, the network device 101 may add parameters (uplinkBWP-ToAddModListRedCap) in an uplink bandwidth part list for the unconventional terminal in uplink configuration (UplinkConfig) of configuration of the serving cell. Each element in the list is configuration information of a first additional uplink BWP, and parameters in the first additional uplink BWP configuration (BWP-UplinkRedCap) may reuse the uplink common BWP configuration of the conventional terminal, including the BWP identifier, the uplink common BWP configuration of the unconventional terminal, and uplink dedicated BWP configuration of the unconventional terminal.

For example, Table 5 below shows an example of adding the configuration information of the first additional uplink bandwidth part in the uplink configuration of the serving cell.

TABLE 5

| | |
|---|---|
| UplinkConfig ::= | SEQUENCE { |
| initialUplinkBWP | BWP-UplinkDedicated |
| OPTIONAL, -- Need M | |
| uplinkBWP-ToReleaseList | SEQUENCE (SIZE (1..maxNrofBWPs)) OF |
| BWP-Id OPTIONAL, | -- Need N |
| uplinkBWP-ToAddModList | SEQUENCE (SIZE (1..maxNrofBWPs)) OF |
| BWP-Uplink OPTIONAL, | -- Need N |
| uplinkBWP-ToAddModListRedCap | SEQUENCE (SIZE (1..maxNrofBWPs)) OF |
| BWP-UplinkRedCap OPTIONAL, -- Need N | |
| firstActiveUplinkBWP-Id | BWP-Id |
| OPTIONAL, -- Cond SyncAndCellAdd | |
| pusch-ServingCellConfig | SetupRelease { PUSCH-ServingCellConfig |
| } OPTIONAL, | --Need M |
| carrierSwitching | SetupRelease { SRS-CarrierSwitching } |
| OPTIONAL, -- Need M | |
| ... , | |

The dedicated configuration (BWP UplinkDeducatedRedCap) of the first additional uplink bandwidth part is dedicated configuration on the BWP for the terminal, wherein parameter items may be identical to those of the second additional uplink bandwidth part, or may be new parameter items not included in the second additional uplink bandwidth part. Identical parameter items may reuse the second additional uplink bandwidth part configuration, including physical uplink control channel configuration, configuration of a configured grant, uplink shared channel configuration, uplink sounding reference signal configuration, and beam failure recovery configuration, etc. Parameter items that must be reused are not included in the first additional uplink bandwidth part configuration.

Reusable and independently configurable parameter items (i.e. second optional parameters) may be included in the common configuration of the first additional uplink bandwidth part. For these parameters, if they are present in the common configuration of the first additional uplink bandwidth part, the unconventional terminal uses contents of these parameters, and if they are not present, the unconventional terminal reuses contents of corresponding parameters with identical BWP identifiers in the common configuration of the second additional uplink bandwidth part. The corresponding parameters refer to parameters in the common configuration of the second additional BWP with BWP identifiers identical to those of the first additional BWP.

Reusable and independently configurable parameter items (i.e. third optional parameters) may be included in the common configuration of the first additional uplink bandwidth part. For these parameters, if they are present in the dedicated configuration of the first additional uplink bandwidth part, the unconventional terminal uses contents of these parameters, and if they are not present, the unconventional terminal reuses contents of corresponding parameters with identical BWP identifiers in the common configuration of the second additional uplink bandwidth part. The corresponding parameters refer to parameters in the dedicated configuration of the second additional BWP with BWP identifiers identical to those of the first additional BWP.

For example, Table 6 below shows an example of the dedicated configuration of the first additional uplink bandwidth part configuration.

TABLE 6

| | |
|---|---|
| BWP-UplinkDedicatedRedCap ::= | SEQUENCE { |
| pucch-Config | SetupRelease { PUCCH-Config } |
| OPTIONAL, -- Need S | |
| pusch-Config | SetupRelease { PUSCH-Config } |
| OPTIONAL, -- Need S | |
| configuredGrantConfig | SetupRelease { ConfiguredGrantConfig } |
| OPTIONAL, -- Need S | |
| srs-Config | SetupRelease { SRS-Config } |
| OPTIONAL, -- Need S | |
| beamFailureRecoveryConfig | SetupRelease { BeamFailureRecoveryConfig } |
| OPTIONAL, -- Cond SpCellOnly | |
| ..., | |
| [[ | |
| cp-ExtensionC2-r16 | INTEGER (1..28) |
| OPTIONAL, -- Need S | |
| cp-ExtensionC3-r16 | INTEGER (1..28) |

In method 2, the network device may configure the unconventional terminal with a BWP different from that of the conventional terminal, that is, in addition to the random access configuration different from that of the conventional terminal, such as the RACH configuration of msg1, the PUSCH configuration of MsgA, or the RACH configuration of two-step random access, the network device may further configure the unconventional terminal with other BWP-related parameters, so as to better support the unconventional terminal, such as a frequency domain location or bandwidth part size of the BWP.

### Method 3

In method 3, the network device 101 may directly transmit the first random access configuration information used for the unconventional terminal and the second random access configuration information used for the conventional terminal. In addition, the unconventional terminal and the conventional terminal may share other configurations of the BWP.

The network device 101 may configure random access parameters used for the unconventional terminal on the initial BWP via the system information, or configure random access parameters used for the unconventional terminal on multiple additional BWPs via dedicated RRC signaling.

In at least one implementation, the first random access configuration information includes first random access configuration information of a third initial uplink bandwidth part transmitted via the system information. And the second random access resource configuration information includes second random access configuration information of the third uplink initial bandwidth part transmitted via the system information.

The third uplink initial bandwidth part is a BWP shared by the unconventional terminal and the conventional terminal, which belongs to the normal uplink (NUL) carrier or the supplementary uplink (SUL) carrier of the serving cell.

In at least one other implementation, the first random access configuration information includes first random access configuration information of at least one third uplink additional bandwidth part transmitted via dedicated radio resource control (RRC) signaling. And the second random access configuration information includes second random access configuration information of at least one third uplink additional bandwidth part transmitted via dedicated radio resource control (RRC) signaling.

The third uplink additional bandwidth part is a BWP shared by the unconventional terminal and the conventional terminal, and partially belongs to the normal uplink (NUL) carrier or supplementary uplink (SUL) carrier of the serving cells. The third uplink additional bandwidth part is an additional bandwidth part other than the initial uplink bandwidth part.

The third uplink initial bandwidth part or the third additional uplink bandwidth part may configure parameters for random access of the unconventional terminal. For example, common RACH configuration or two-step random access common RACH configuration for performing random access by the unconventional terminal may be added to uplink common BWP configuration of an existing conventional terminal, thereby forming the common configuration of the third uplink initial bandwidth part or the third additional uplink bandwidth part, as shown in Table 7 below.

TABLE 7

| | |
|---|---|
| BWP-UplinkCommon ::= | SEQUENCE { |
| genericParameters | BWP, |
| rach-ConfigCommon | SetupRelease { RACH-ConfigCommon } |
| OPTIONAL, -- Need M | |
| pusch-ConfigCommon | SetupRelease { PUSCH-ConfigCommon } |
| OPTIONAL, -- Need M | |
| pucch-ConfigCommon | SetupRelease { PUCCH-ConfigCommon } |
| OPTIONAL, -- Need M | |
| ..., | |
| [ [ | |
| rach-ConfigCommonIAB-r16 | SetupRelease { RACH-ConfigCommonIAB-r16 } |
| OPTIONAL, -- Need M | |
| useInterlacePUCCH-PUSCH-r16 | ENUMERATED {enabled} |
| OPTIONAL, -- Need M | |

Parameter items in the common RACH configuration (RACH ConfigCommonRedCap) (i.e. the first random access configuration information) used for performing random access by the unconventional terminal are identical to those in the RACH common configuration of the conventional terminal, or they are new parameter items not included in the RACH common configuration of the conventional terminal. For identical parameter items, they may be reused or independently configured by the unconventional terminal relative to the RACH common configuration of the conventional terminal. The identical parameter items include, for example, basic parameters of the RACH, configuration of groupB, the number of available preambles, SSB-based RO configuration, an RSRP threshold of an SSB, a contention resolution timer, and a PRACH root sequence index, etc., wherein time domain and frequency domain positions of the PRACH occasion are included in the basic parameters of the RACH.

Parameter items that must be reused are not included in the random access configuration used for the unconventional terminal. Reusable and separately configurable parameters (i.e. fourth optional parameters) are included in the common RACH configuration (i.e. the first random access configuration information) of the unconventional terminal, and for these parameters, if they are present in the common RACH configuration of the unconventional terminal, the unconventional terminal uses contents the parameters, and if they are not present, the unconventional terminal may reuse contents of corresponding parameters in the common RACH configuration (i.e. the second random access configuration information) of the conventional terminal on a related BWP.

For example, if an RO in the common RACH configuration of the unconventional terminal is shared with the PRACH RO of the conventional terminal, the PRACH RO of the unconventional terminal must reuse the PRACH RO configuration of the conventional terminal, hence, parameter items related to RO configuration are not included in the common RACH configuration accessed by the unconventional terminal; and furthermore, the common RACH configuration of the unconventional terminal may include a parameter to indicate the number of preambles that may be used by the unconventional terminal.

Table 8 is an example of the common RACH configuration (RACH-ConfigCommonRedCap) for performing random access by the unconventional terminal.

TABLE 8

| | |
|---|---|
| RACH-ConfigCommonRedCap ::= | SEQUENCE { |
| rach-ConfigGeneric | RACH-ConfigGeneric, |
| OPTIONAL, -- Need S | |
| totalNumberOfRA-Preambles | INTEGER (1..63) |
| OPTIONAL, -- Need S | |
| ssb-perRACH-OccasionAndCB-PreamblesPerSSB CHOICE { | |
| oneEighth | ENUMERATED |
| {n4,n8,n12,n16,n20,n24,n28,n32,n36,n40,n44,n48,n52,n56,n60,n64}, | |
| oneFourth | ENUMERATED |
| {n4,n8,n12,n16,n20,n24,n28,n32,n36,n40,n44,n48,n52,n56,n60,n64}, | |
| oneHalf | ENUMERATED |
| {n4,n8,n12,n16,n20,n24,n28,n32,n36,n40,n44,n48,n52,n56,n60,n64}, | |
| one | ENUMERATED |
| {n4,n8,n12,n16,n20,n24,n28,n32,n36,n40,n44,n48,n52,n56,n60,n64}, | |
| two | ENUMERATED |
| {n4,n8,n12,n16,n20,n24,n28,n32}, | |
| four | INTEGER (1..16), |
| eight | INTEGER (1..8), |
| sixteen | INTEGER (1..4) |
| } | |
| OPTIONAL, -- Need S | |
| groupBconfigured | SEQUENCE { |
| ra-Msg3SizeGroupA | ENUMERATED {b56, b144, b208, |
| b256, b282, b480, b640, | |
| | b800, b1000, b72, |
| spare6, spare5,spare4, spare3, spare2, spare1}, | |
| messagePowerOffsetGroupB | ENUMERATED { minusinfinity, |
| dB0, dB5, dB8, dB10, dB12, dB15, dB18}, | |
| numberOfRA-PreamblesGroupA | INTEGER (1..64) |
| } | |
| OPTIONAL, -- Need S | |
| ra-ContentionResolutionTimer | ENUMERATED { sf8, sf16, sf24, |
| sf32, sf40, sf48, sf56, sf64}, | |
| rsrp-ThresholdSSB | RSRP-Range |
| OPTIONAL, -- Need S | |

For another example, in a case where the RO in the common RACH configuration of the unconventional terminal is independent of the PRACH RO of the conventional terminal, the parameters related to the RO configuration of the RACH of the unconventional terminal are inevitable or optional in the common RACH configuration of the unconventional terminal. And if the RO configuration parameters are present in the common RACH configuration of the unconventional terminal, the unconventional terminal uses contents of the parameters, and they are not present, the unconventional terminal may reuse corresponding parameters in the common RACH configuration of the conventional terminal on a related BWP.

Reusable and independently configurable parameter items (i.e. fifth optional parameters) may be included in first random access configuration information of the third additional uplink bandwidth part. For these parameters, if they are present in the first random access configuration information of the third additional uplink bandwidth part, the unconventional terminal uses contents of these parameters, and if they are not present, the unconventional terminal reuses contents of corresponding parameters in second random access configuration information of the third additional uplink bandwidth part.

In this disclosure, the first random access and the second random access may share a random access occasion (RO); or, the random access occasion (RO) of the first random access is independent of the random access occasion (RO) of the second random access. A parameter used for indicating the number of preambles that may be used by the unconventional terminal in an RO may be included in an independent RO or a shared RO.

The third uplink initial bandwidth part or the third additional uplink bandwidth part may configure an MsgA PUSCH for random access of the unconventional terminal. For example, MsgA PUSCH configuration for performing two-step random access by the unconventional terminal may be added to uplink common BWP configuration (BWP-UplinkCommon) of an existing conventional terminal, as shown in Table 9 below.

TABLE 9

| | |
|---|---|
| BWP-UplinkCommon ::= | SEQUENCE { |
| genericParameters | BWP, |
| rach-ConfigCommon | SetupRelease { RACH-ConfigCommon } |
| OPTIONAL, -- Need M | |
| pusch-ConfigCommon | SetupRelease { PUSCH-ConfigCommon } |
| OPTIONAL, -- Need M | |
| pucch-ConfigCommon | SetupRelease { PUCCH-ConfigCommon } |
| OPTIONAL, -- Need M | |
| ..., | |
| [ [ | |
| rach-ConfigCommonIAB-r16 | SetupRelease { RACH-ConfigCommonIAB-r16 } |
| OPTIONAL, -- Need M | |
| useInterlacePUCCH-PUSCH-r16 | ENUMERATED {enabled} |

In method 3, the unconventional terminal and the conventional terminal may share other configurations than the random access configuration, and may further share a part of the random access configuration, which is conducive to saving signaling costs.

### Embodiment 2

In embodiment 2, the first random access configuration information includes first uplink grant configuration information for the unconventional terminal to transmit a third message (msg3). And the second random access configuration information includes second uplink grant configuration information for the conventional terminal to transmit the third message (msg3).

In embodiment 2, the network device 101 may transmit to the unconventional terminal uplink grant configuration (i.e. the first random access configuration information) of msg3 for performing random access by the unconventional terminal, and then receive msg3 transmitted by the unconventional terminal with the uplink grant configuration.

In embodiment 2, the first random access configuration information includes first uplink grant configuration information transmitted via a random access response (RAR) for the unconventional terminal to transmit the third message (msg3); and the second random access configuration information includes second uplink grant configuration information transmitted via a random access response (RAR) for the conventional terminal to transmit the third message (msg3). The uplink grant configuration information includes size and location information of time-frequency domain resources of the msg3 PUSCH, a modulation and coding scheme or frequency hopping configuration, etc.

For example, the network device 101 may add an uplink grant (such as RedCap UL Grant) to the RAR for the unconventional terminal to transmit Msg3. If an MAC layer of the unconventional terminal successfully receives the RAR, it processes the received uplink grant and indicates the uplink grant to a physical layer, and the physical layer uses the uplink grant to transmit msg3; and if the network device 101 detects msg3 on a resource indicated by the uplink grant, it may be determined that msg3 transmitted by the unconventional terminal is received.

The uplink grant configuration used for the unconventional terminal may only contain configuration information different from that of the conventional terminal, such as only containing time-frequency domain resource information, or a modulation and coding scheme, etc.

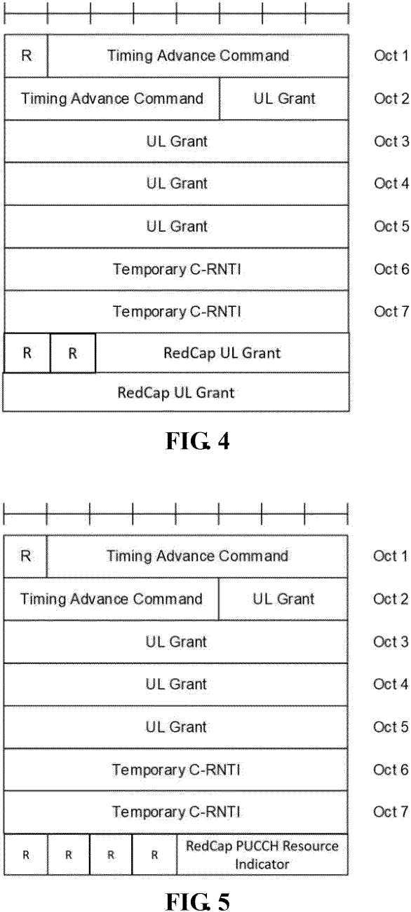

FIG. 4 is a schematic diagram of the RAR transmitted by the network device to the unconventional terminal. As shown in FIG. 4, the RAR includes that the uplink grant RedCap UL Grant occupies 14 bits, which may be used to configure frequency domain resources of the msg3 different from those of the conventional terminal. Reference may be made to relevant technologies for meanings of other fields of the RAR. In addition, in FIG. 4, Oct denotes an octal field. The uplink grant configuration used for the unconventional terminal is not limited to the example shown in FIG. 4.

### Embodiment 3

In Embodiment 3, the first random access configuration information includes physical uplink control channel (PUCCH) configuration for performing HARQ feedback on the fourth message (msg4), or physical uplink control channel (PUCCH) configuration for performing HARQ feedback on the fifth message (MsgB).

In Embodiment 3, the network device 101 transmits to the unconventional terminal PUCCH configuration information for the unconventional terminal to perform HARQ feedback on msg4 or MsgB, and the unconventional terminal perform HARQ feedback on msg4 or MsgB by using the PUCCH configuration; and the PUCCH configuration includes configuration of PUCCH resources or transmission modes. The network device 101 may determine that the terminal equipment is an unconventional terminal according to the PUCCH resource location used by the HARQ feedback.

In at least one implementation, the first random access configuration information includes first physical uplink control channel (PUCCH) configuration information for performing HARQ feedback on the fourth message (msg4) by the unconventional terminal transmitted via a random access response (RAR). And the second random access configuration information includes second physical uplink control channel (PUCCH) configuration information for performing HARQ feedback on the fourth message (msg4) by the conventional terminal transmitted via a random access response (RAR).

In at least one other implementation, the first random access configuration information includes third physical uplink control channel (PUCCH) configuration information for performing HARQ feedback on the fourth message (msg4) transmitted via a fallback random access response (fallbackRAR). And the second random access configuration information includes fourth physical uplink control channel (PUCCH) configuration information for performing HARQ feedback on the fourth message (msg4) transmitted via the fallback random access response (fallbackRAR).

For example, a PUCCH resource indicator for performing HARQ feedback on msg4 by the unconventional terminal is added to the RAR or fallbackRAR of msg2. After the random access is successful (for example, the contention resolution is successful), the unconventional terminal instructs the physical layer (MAC) to generate HARQ feedback, and the physical layer uses a PUCCH resource for the unconventional terminal to perform HARQ feedback on msg4.

FIG. 5 is a schematic diagram of the RAR or fallbackRAR transmitted by the network device to the unconventional terminal. As shown in FIG. 5, the RAR or fallbackRAR includes a PUCCH resource indicator, i.e. RedCap PUCCH Resource Indicator, which is used to indicate the PUCCH resource used by the unconventional terminal to perform HARQ feedback on msg4. Reference may be made to relevant technologies for meanings of other fields of the RAR or fallbackRAR.

In at least one other implementation, the first random access configuration information includes fifth physical uplink control channel (PUCCH) configuration information for performing HARQ feedback on the fifth message (MsgB) transmitted via a success random access response (successRAR). And the second random access configuration information includes sixth physical uplink control channel (PUCCH) configuration information for performing HARQ feedback on the fifth message (MsgB) transmitted via the success random access response (successRAR).

For example, a PUCCH resource indicator for performing HARQ feedback on MsgB by the unconventional terminal is added to the successRAR of MsgB. After the random access is successful (for example, the contention resolution is successful), the unconventional terminal instructs the physical layer to generate HARQ feedback, and transmit the PUCCH resource indicator used for the unconventional terminal to the physical layer, and the physical layer (MAC) uses the PUCCH resource used for the unconventional terminal to perform HARQ feedback on MsgB.

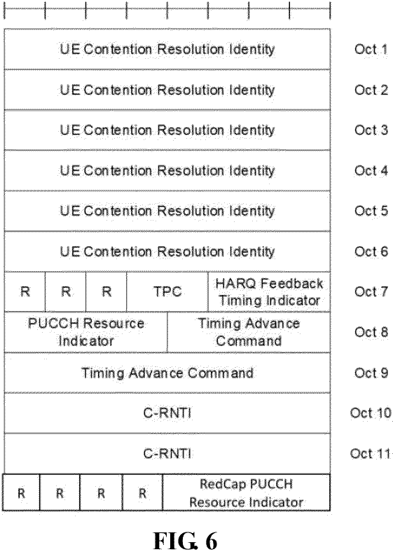

FIG. 6 is a schematic diagram of the successRAR of MsgB transmitted by the network device to the unconventional terminal. As shown in FIG. 6, the successRAR includes the PUCCH resource indicator, i.e. RedCap PUCCH Resource Indicator, which is used to indicate the PUCCH resource instructing the unconventional terminal to perform HARQ feedback on MsgB. Reference may be made to relevant technologies for meanings of other fields of successRAR.

According to the first aspect of the embodiments of this disclosure, the network device transmits the first random access configuration information used for the unconventional terminal and the second random access configuration information used for the conventional terminal to the terminal equipment, receives the message transmitted by the unconventional terminal according to the first random access configuration, and then performs data transmission with the unconventional terminal by using an unconventional transmission mode. Hence, the network device is able to perform differentiated configuration and processing on the conventional terminal and the unconventional terminal during the random access procedure based on the relatively low performance of the unconventional terminal, so that a terminal is able to perform random access with the configuration matching its performance, and is able to subsequently transmit data with an unconventional terminal in a manner matching the performance of the unconventional terminal, thereby making the system able to support the unconventional terminal equipment in the whole communication process, and lowering application cost of the 5G system.

### Second Aspect of Embodiments

The second aspect of embodiments of this disclosure relates to a method for transmission and reception of a signal, applicable to a network device, such as the network device 101.

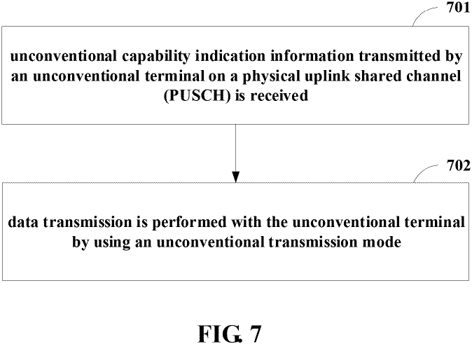

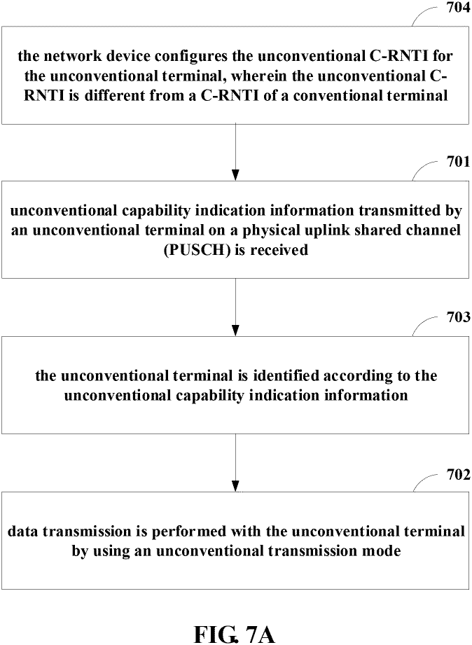

FIG. 7 is a schematic diagram of the method for transmission and reception of a signal of the second aspect of the embodiments of this disclosure. As shown in FIG. 7, the method for transmission and reception of a signal may include:
operation 701: unconventional capability indication information transmitted by an unconventional terminal on a physical uplink shared channel (PUSCH) is received; and
operation 702: data transmission is performed with the unconventional terminal by using an unconventional transmission mode.

In operation 702, the unconventional transmission mode includes at least one of the following: a transmission bandwidth is lower than a bandwidth supported by the conventional terminal, the number of antennas is less than the number of antennas supported by the conventional terminal, the number of HARQ processes is less than the number of HARQ processes supported by the conventional terminal, a modulation and coding scheme is lower than a modulation and coding scheme supported by the conventional terminal, a half duplex frequency division duplex mode, or a transport block size is smaller than that supported by the conventional terminal.

FIG. 7A is another schematic diagram of the method for transmission and reception of a signal of the second aspect of the embodiments of this disclosure, as shown in FIG. 7A, the method further includes:

operation 703: the unconventional terminal is identified according to the unconventional capability indication information.

Operation 703 may be executed after operation 701 and before operation 702.

According to the second aspect of the embodiments of this disclosure, the network device receives the unconventional capability indication information, which is used to indicate that the terminal is an unconventional terminal. Therefore, the network device is able to identify the unconventional terminal according to the unconventional capability indication information, so that it may perform data transmission with the unconventional terminal in a manner matching the performance of the unconventional terminal, thereby lowering cost and power consumption of the unconventional terminal equipment.

The method for transmission and reception of a signal of the second aspect of the embodiments of this disclosure shall be described below by way of different embodiments.

### Embodiment 1

In Embodiment 1, the unconventional capability indication information may include an unconventional capability media access control control unit (MAC CE).

In this embodiment, the unconventional capability MAC CE may be transmitted via msg3 PUSCH or MsgA PUSCH, or the unconventional capability MAC CE may be transmitted in any PUSCH on uplink after the random access of the unconventional terminal is successful.

For example, in a four-step random access procedure, if an unconventional terminal successfully receives an RAR of Msg2 and receives the RAR for the first time in the random access procedure, an MAC entity indicates that a multiplexing and assembly entity includes an unconventional MAC CE in an Msg3 media access control protocol data unit (MAC PDU), obtains the Msg3 MAC PDU from the multiplexing and assembly entity, and saves the Msg3 MAC PDU in an msg3 buffer.

For another example, in a two-step random access procedure, when an unconventional terminal transmits MsgA for the first time in a random access procedure, an MAC entity of the unconventional terminal indicates that a multiplexing and assembly entity includes an unconventional MAC CE in an MsgA MAC PDU, obtains the MsgA MAC PDU from the multiplexing and assembly entity, and saves the MsgA MAC PDU in an MsgA buffer.

In Embodiment 1, the terminal may transmit unconventional indication information in an msg3 or MsgA message, so that network device may identify the unconventional terminal as early as possible, and may use an appropriate transmission mode for the unconventional terminal as early as possible, or apply a more efficient power saving mechanism as soon as possible, so as to better support the unconventional terminal; moreover, the unconventional terminal may transmit the unconventional capability indication without any configuration of the network device, which is conducive to saving downlink signaling cost.

### Embodiment 2

In Embodiment 2, the unconventional capability indication information may include an unconventional cell radio network temporary identifier (C-RNTI) for scrambling an uplink shared channel (PUSCH).

In this embodiment, the scrambled PUSCH may be an Msg3 PUSCH or an MsgA PUSCH, or may be other PUSCHs.

For example, a C-RNTI domain for the unconventional terminal, such as a RedCap Temporary C-RNTI domain, is added to the RAR of Msg2 in the four-step random access or fallbackRAR of MsgB in the two-step random access. If the unconventional terminal successfully receives the RAR or fallback RAR, it sets a temporary C-RNTI of the unconventional terminal itself to be of a value of the received RedCap temporary C-RNTI domain, and the unconventional terminal uses the value to scramble the msg3 PUSCH in transmitting the msg3 PUSCH; and furthermore, when the network device detects that msg3 is scrambled by the RedCap Temporary C-RNTI, it determines that the terminal is an unconventional terminal.

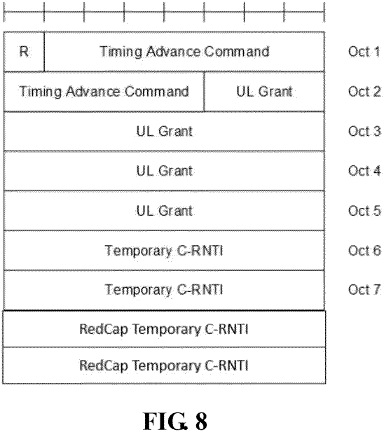

FIG. 8 is a schematic diagram of the RAR or fallbackRAR transmitted by network device to the unconventional terminal. As shown in FIG. 8, the RAR or fallbackRAR includes a C-RNTI domain used for the unconventional terminal, i.e. the RedCap Temporary C-RNTI domain. Reference may be made to relevant technologies for meanings of other fields of the RAR or fallbackRAR.

For another example, a C-RNTI domain for the unconventional terminal, such as a RedCap C-RNTI domain, is added to the successRAR of MsgB in the two-step random access. If the unconventional terminal successfully receives the successRAR, it sets a C-RNTI of the unconventional terminal itself to be of a value of the received RedCap C-RNTI domain. The unconventional terminal uses the value to scramble the PUSCH after transmitting a subsequent PUSCH, and when the network device detects that msg3 is transmitted via the PUSCH scrambled by the RedCap C-RNTI, it determines that the terminal is an unconventional terminal.

In Embodiment 2, the terminal may transmit the unconventional indication information via the C-RNTI scrambling msg3 or MsgA, so that network device may identify the unconventional terminal as early as possible, and may use an appropriate transmission mode for the unconventional terminal as early as possible, or apply a more efficient power saving mechanism as soon as possible, so as to better support the unconventional terminal; moreover, the scrambling needs no additional uplink signaling, which is conducive to saving uplink signaling cost.

### Embodiment 3

In Embodiment 3, the unconventional capability indication information may include an MAC CE containing an unconventional C-RNTI transmitted via an uplink shared channel (PUSCH).

In this embodiment, the PUSCH may be an msg3 PUSCH or an MsgA PUSCH, or may be other PUSCHs.

For example, a C-RNTI domain for the unconventional terminal, such as a RedCap Temporary C-RNTI domain, is added to the RAR of Msg2 of the four-step random access. If the unconventional terminal successfully receives the RAR of msg2 and receives the RAR for the first time in the random access procedure, it sets a temporary C-RNTI of the unconventional terminal itself to be of a value of the received RedCap temporary C-RNTI domain. Thereafter, the MAC entity instructs the multiplexing and assembly entity to include a C-RNTI MAC CE in the msg3 MAC PDU, the C-RNTI MAC CE containing an updated temporary C-RNTI value, and obtains the msg3 MAC PDU from the multiplexing and assembly entity, and saves the msg3 MAC PDU in the msg3 buffer; or, after the random access is successful (for example, the contention solution is successful), the unconventional terminal sets the C-RNTI of itself to be a temporary C-RNTI, and the multiplexing and assembly entity includes the C-RNTI MAC CE in a subsequent first PUSCH MAC PDU.

For another example, an unconventional C-RNTI domain (e.g. a RedCap C-RNTI domain) is added to the successRAR of MsgB in the two-step random access, or a temporary C-RNTI domain (e.g. an RedCap Temporary C-RNTI) used for the unconventional terminal is added to the fallback RAR.

If the unconventional terminal successfully receives the successRAR, it sets a C-RNTI of itself to be of a value of the received RedCap C-RNTI field. And the multiplexing and assembly entity contains a C-RNTI MAC CE in a subsequent first PUSCH MAC PDU, the C-RNTI MAC CE containing the updated C-RNTI value.

If the unconventional terminal successfully receives the fallbackRAR, it sets Temporary C-RNTI of itself to be the received RedCap Temporary C-RNTI. After the random access is successful (for example, the contention solution is successful), the unconventional terminal sets a value of the C-RNTI domain of itself to be of a value of the received RedCap Temporary C-RNTI domain. And the multiplexing and assembly entity contains a C-RNTI MAC CE in a subsequent first PUSCH MAC PDU, the C-RNTI MAC CE containing the updated C-RNTI value.

In Embodiment 2, the terminal may transmit the unconventional indication information via the C-RNTI contained in msg3 or MsgA, so that network device may identify the unconventional terminal as early as possible, and use an appropriate transmission mode for the unconventional terminal as early as possible, or apply a more efficient node mechanisms as soon as possible, so as to better support the unconventional terminal.

In embodiments 2 and 3, the unconventional C-RNTI may be a preset RNTI specially used for the unconventional terminal, or may be of a value configured by the network device.

In embodiments 2 and 3, the method shown in FIG. 7A may further include:

operation 704: the network device configures the unconventional C-RNTI for the unconventional terminal, wherein the unconventional C-RNTI is different from a C-RNTI of a conventional terminal.

In operation 704, the unconventional C-RNTI may be transmitted to the unconventional terminal via a random access response (RAR) or a fallback random access response (fallbackRAR); or, the unconventional C-RNTI is transmitted to the unconventional terminal via a success random access response (successRAR).

In embodiments 2 and 3, operation 704 may be executed before operation 701.

According to the second aspect of the embodiments of this disclosure, the network device receives the unconventional capability indication information, which is used to indicate that the terminal is an unconventional terminal. Therefore, the network device is able to identify the unconventional terminal according to the unconventional capability indication information, so that it may perform data transmission with the unconventional terminal in a manner matching the performance of the unconventional terminal. Thus, cost and power consumption of unconventional terminal equipment may be lowered.

### Third Aspect of Embodiments

The second aspect of embodiments of this disclosure relates to a method for transmission and reception of a signal, applicable to a terminal equipment, such as the terminal equipment 102. The terminal equipment is, for example, an unconventional terminal equipment.

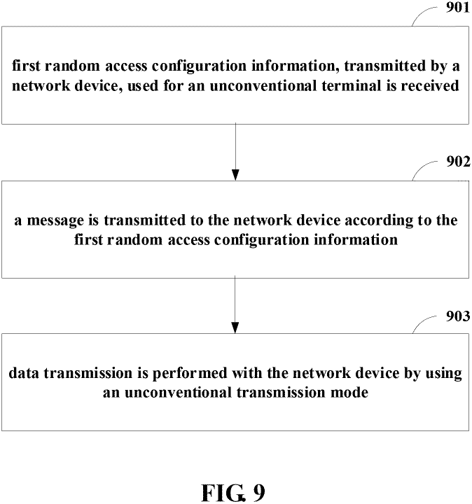

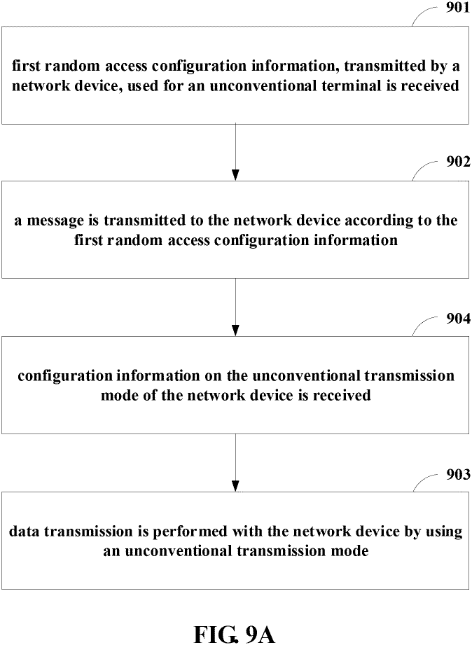

FIG. 9 is a schematic diagram of the method for transmission and reception of a signal of the third aspect of the embodiments of this disclosure. As shown in FIG. 9, the method for transmission and reception of a signal may include:
operation 901: first random access configuration information, transmitted by a network device, used for an unconventional terminal is received;
operation 902: a message is transmitted to the network device according to the first random access configuration information; and
operation 903: data transmission is performed with the network device by using an unconventional transmission mode.

According to the third aspect of the embodiments of this disclosure, the terminal equipment may receive the first random access configuration information transmitted by the network device for the unconventional terminal, transmit a message to the network device in the first random access configuration, and then perform data transmission with the network device by using the unconventional transmission mode. Thus, the unconventional terminal may perform random access in a manner matching its performance, and may subsequently perform data transmission with the network devices in a manner matching its performance, so that the system may support unconventional terminal equipments in the entire communication process, thereby lowering application cost of the 5G system.

In at least one embodiment, the first random access configuration in operation 901 is at least one of the following configurations:
random access channel (RACH) configuration of a first message (msg 1);
physical uplink shared channel (PUSCH) configuration of a third message (msg 3);
random access channel (RACH) configuration of a second message (Msg A) in two-step random access;
PUSCH configuration of the second message (Msg A);
physical uplink control channel (PUCCH) configuration performing HARQ feedback on a fourth message (msg 4); or
physical uplink control channel (PUCCH) configuration performing HARQ feedback on a fifth message (Msg B).

In operation 903, the unconventional transmission mode includes at least one of the following: being lower than a bandwidth supported by the conventional terminal, being less than the number of antennas supported by the conventional terminal, being less than the number of HARQ processes supported by the conventional terminal, being lower than a modulation and coding scheme supported by the conventional terminal, a half-duplex frequency-division duplex mode, or being smaller than a transport block size supported by the conventional terminal.

As shown in FIG. 9A, the method further includes:

operation 904: configuration information on the unconventional transmission mode of the network device is received.

The unconventional transmission mode and its related configuration may be activated by operation 904. Operation 904 may be, for example, before operation 903.

The method for transmission and reception of a signal of FIG. 9 shall be described below by way of different embodiments.

### Embodiment 1

In Embodiment 1, the first random access configuration information may be: RACH configuration of a first message (msg1), or RACH configuration of a second message (msgA) in two-step random access, or PUSCH configuration of the second message (MsgA) in two-step random access. For example, the network device 101 transmits the RACH configuration for performing random access to the terminal equipment 102, and the terminal equipment transmits a preamble of the first message msg1 or the second message MsgA according to the RACH configuration.

Embodiment 1 may be implemented in multiple ways.

### Method 1

In method 1, the receiving first random access configuration information used for an unconventional terminal includes:

receiving first system information used for the unconventional terminal.

In at least one embodiment, the first system information includes a first master information block (MIB) and a first system information block 1 (SIB1), the first master information block including configuration information used for scheduling a physical downlink control channel (PDCCH) of the first system information block 1, wherein the first system information block 1 includes the first random access configuration information used for the unconventional terminal.

In Embodiment 1, the method may further include: receiving second system information used for the conventional terminal by the unconventional terminal.

The second system information includes a second master information block and a second system information block 1, the second master information block including configuration information used for scheduling a PDCCH of the second system information block 1, wherein the second system information block 1 includes second random access configuration information used for the conventional terminal.

In Embodiment 1, the first master information block further contains an unconventional identifier, which is used to indicate that the first master information block contains configuration information used for receiving the physical downlink control channel (PDCCH) of the first system information block 1.

In at least one other implementation, the first system information includes a third master information block, a third system information block 1 and a fourth system information block 1 (SIB1), wherein the third master information block contains configuration information used for scheduling a PDCCH of the third system information block 1, the third system information block 1 contains configuration information used for scheduling a PDCCH of the fourth system information block 1, and the fourth system information block 1 includes the first random access configuration information.

The third system information block 1 further includes the second random access configuration information used for the conventional terminal.

### Method 2

The receiving first random access configuration information used for an unconventional terminal includes:

receiving first uplink bandwidth part (BWP) configuration information used for the unconventional terminal.

The first uplink bandwidth part configuration information includes first initial uplink bandwidth part configuration information received via system information, wherein the first initial uplink bandwidth part configuration information includes common configuration of a first initial uplink bandwidth part.

The first initial uplink bandwidth part belongs to a normal uplink (NUL) carrier or a supplementary uplink (SUL) carrier of a serving cell.

In at least one implementation, the method further includes: receiving second uplink bandwidth part (BWP) configuration information used for the conventional terminal.

The second uplink bandwidth part configuration information includes second initial uplink bandwidth part configuration information received via the system information, wherein the second initial uplink bandwidth part configuration information includes common configuration of a second initial uplink bandwidth part.

If a first optional parameter is not configured in the common configuration of the first initial uplink bandwidth part, the terminal applies corresponding parameters in the common configuration of the second initial uplink bandwidth part.

The common configuration of the first initial uplink bandwidth part includes configuration information of the first random access resource.

The first uplink bandwidth part configuration information includes:

at least one piece of first additional uplink bandwidth part configuration information transmitted via dedicated radio resource control (RRC) signaling, wherein the first additional uplink bandwidth part configuration information includes a BWP identifier of a first additional uplink bandwidth part, common configuration of the first additional uplink bandwidth part and/or dedicated configuration of the first additional uplink bandwidth part.

In at least one other implementation, the method further comprises:

receiving third uplink bandwidth part (BWP) configuration information used for the conventional terminal.

The third uplink bandwidth part configuration information includes:

at least one piece of second additional uplink bandwidth part configuration information received via dedicated radio resource control (RRC) signaling.

The second additional uplink bandwidth part configuration information includes a BWP identifier of a second additional uplink bandwidth part, common configuration of the second additional uplink bandwidth part, and/or dedicated configuration of the second additional uplink bandwidth part.

If the second optional parameters are not configured in the common configuration of the first additional uplink bandwidth part, the terminal applies corresponding parameters in common configuration of the second additional uplink bandwidth part; or, if the third optional parameters are not configured in the dedicated configuration of the first additional uplink bandwidth part, the terminal applies corresponding parameters in the dedicated configuration of the second additional uplink bandwidth part.

The common configuration of the first additional uplink bandwidth part includes the first random access configuration information.

### Method 3

In one implementation, the first random access configuration information includes first random access configuration information of a third initial uplink bandwidth part received via the system information.

The third initial uplink bandwidth part belongs to a normal uplink (NUL) carrier or a supplementary uplink (SUL) carrier of a serving cell.

The method further includes:

receiving third random access configuration information used for the conventional terminal, the third random access configuration information including third random access configuration information of the third initial uplink bandwidth part received via the system information.

If the fourth optional parameters are not configured in the first random access configuration information of the third initial uplink bandwidth part, the terminal applies corresponding parameters in the third random access configuration information of the third initial uplink bandwidth part.

In one implementation, the first random access configuration information includes first random access configuration information on at least one third additional uplink bandwidth part received via dedicated radio resource control (RRC) signaling.

The method further includes:

receiving fourth random access configuration information used for the conventional terminal, the fourth random access configuration information including fourth random access configuration information of at least one third additional uplink bandwidth part received via dedicated radio resource control (RRC) signaling.

If the fifth optional parameters are not configured in the first random access configuration information of the third additional uplink bandwidth part, the terminal applies corresponding parameters in the fourth random access configuration information of the third additional uplink bandwidth part.

The first random access shares a random access occasion (RO) with the fourth random access; or, a random access occasion (RO) of the first random access is independent of a random access occasion (RO) of the fourth random access.

The first random access configuration information includes the number of preambles that may be used by the unconventional terminal in a random access occasion (RO).

### Embodiment 2

The first random access configuration information includes first uplink grant configuration information received via a random access response (RAR) and used for transmitting the third message (msg3).

The random access response further carries second uplink grant configuration information used for the conventional terminal to transmit the third message (msg3).

The method further includes:
processing the received first uplink grant configuration information, and indicating a first uplink grant to a physical layer, by an MAC layer of the unconventional terminal and
transmitting the third message (msg3) by the physical layer by using the first uplink grant.

### Embodiment 3

In at least one implementation, the first random access configuration information includes first physical uplink control channel (PUCCH) configuration information received via a random access response (RAR) and used for performing HARQ feedback on the fourth message (msg4).

The random access response (RAR) further carries the first physical uplink control channel (PUCCH) configuration information for performing HARQ feedback on the fourth message (msg4) by the conventional terminal.

The method further includes:
instructing the physical layer to generate HARQ feedback by the MAC layer after the random access of the unconventional terminal is successful; and
performing HARQ feedback on the fourth message by the physical layer by using a physical uplink control channel (PUCCH) configured by the first physical uplink control channel (PUCCH) configuration information.

In at least one other implementation, the first random access configuration information includes third physical uplink control channel (PUCCH) configuration information received via a fallback random access response (fallbackRAR) and used for performing HARQ feedback on the fourth message (msg4).

The fallback random access response (fallback RAR) further carries the fourth physical uplink control channel (PUCCH) configuration information used for performing HARQ feedback on the fourth message (msg4) by the conventional terminal.

The method further includes:
instructing the physical layer to generate HARQ feedback by the MAC layer after the random access of the unconventional terminal is successful; and
performing HARQ feedback on the fourth message by the physical layer by using a physical uplink control channel (PUCCH) configured by the third physical uplink control channel (PUCCH) configuration information.

In at least one other implementation, the first random access configuration information includes fifth physical uplink control channel (PUCCH) configuration information received via a success random access response (successRAR) and used for performing HARQ feedback on the fifth message (msgB).

The success random access response (successRAR) further carries sixth physical uplink control channel (PUCCH) configuration information used for performing HARQ feedback on the fifth message (msgB) by the conventional terminal.

The method further includes:
instructing the physical layer to generate HARQ feedback by the MAC layer after the random access of the unconventional terminal is successful; and
performing HARQ feedback on the fifth message by the physical layer by using a physical uplink control channel (PUCCH) configured by the fifth physical uplink control channel (PUCCH) configuration information.

Reference may be made to the description of the corresponding embodiments in the method for transmission and reception of a signal of the first aspect of the embodiments of this disclosure for detailed description of the embodiments in the method for transmission and reception of a signal of the third aspect of the embodiments of this disclosure.

### Fourth Aspect of Embodiments

The fourth aspect of embodiments of this disclosure relates to a method for transmission and reception of a signal, applicable to a terminal equipment, such as the terminal equipment 102. The terminal equipment is, for example, an unconventional terminal equipment.

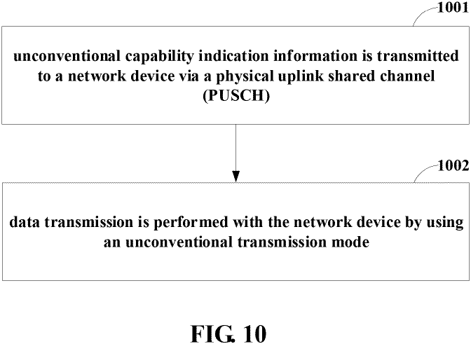

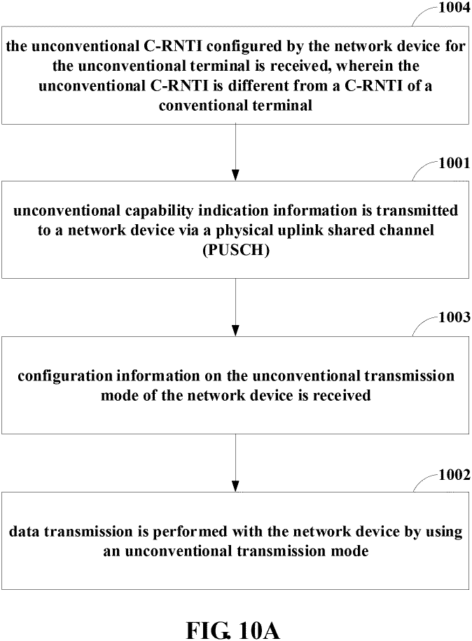

FIG. 10 is a schematic diagram of the method for transmission and reception of a signal of the fourth aspect of the embodiments of this disclosure. As shown in FIG. 10, the method for transmission and reception of a signal may include:
operation 1001: unconventional capability indication information is transmitted to a network device via a physical uplink shared channel (PUSCH); and
operation 1002: data transmission is performed with the network device by using an unconventional transmission mode.

According to the fourth aspect of the embodiments of this disclosure, the terminal equipment transmits the unconventional capability indication information, which is used to indicate that the terminal is an unconventional terminal. Therefore, the network device may identify the unconventional terminal according to the unconventional capability indication information, so that it may perform data transmission with the unconventional terminal in a manner matching the performance of the unconventional terminal. Hence, the cost and power consumption of unconventional terminal equipment may be lowered.

In at least one embodiment, in operation 1002, the unconventional transmission mode includes at least one of the following: being lower than a bandwidth supported by the conventional terminal, being less than the number of antennas supported by the conventional terminal, being less than the number of HARQ processes supported by the conventional terminal, being lower than a modulation and coding scheme supported by the conventional terminal, a half-duplex frequency-division duplex mode, being smaller than a transport block size supported by the conventional terminal.

As shown in FIG. 10, the method further includes:

operation 1003: configuration information on the unconventional transmission mode of the network device is received.

The unconventional transmission mode and its related configuration may be activated by operation1002. Operation 1003 may be, for example, before operation 1002.

The method for transmission and reception of a signal of FIG. 10 shall be described below by way of different embodiments.

### Embodiment 1

In Embodiment 1, the unconventional capability indication information includes:

an unconventional capability indication MAC layer control unit transmitted via a physical uplink shared channel (PUSCH).

The physical uplink shared channel (PUSCH) includes a PUSCH of a third message (msg 3), or a PUSCH of a second message (Msg A), of random access. In addition, physical uplink shared channel (PUSCH) may also be any PUSCH on uplink after successful random access.

### Embodiment 2

The unconventional capability indication information includes an unconventional C-RNTI for scrambling an uplink shared channel (PUSCH).

### Embodiment 3

The unconventional capability indication information includes an MAC layer control unit containing the unconventional C-RNTI transmitted via an uplink shared channel (PUSCH).

In embodiments 2 and 3, the physical uplink shared channel (PUSCH) includes the PUSCH of the third message (msg 3), or the PUSCH of the second message (Msg A), or other PUSCHs, of the random access.

In embodiments 2 and 3, before the transmitting unconventional capability indication information, the method further includes:

operation 1004: the unconventional C-RNTI configured by the network device for the unconventional terminal is received, wherein the unconventional C-RNTI is different from a C-RNTI of a conventional terminal.

The receiving the unconventional C-RNTI configured by the network device for the unconventional terminal includes:

receiving the unconventional C-RNTI via a random access response (RAR) or a fallback random access response (fallbackRAR); or, receiving the unconventional C-RNTI via a success random access response (successRAR).

Reference may be made to the description of the corresponding embodiments in the method for transmission and reception of a signal of the second aspect of the embodiments of this disclosure for detailed description of the embodiments in the method for transmission and reception of a signal of the fourth aspect of the embodiments of this disclosure.

### Fifth Aspect of Embodiments

The fifth aspect of embodiments of this disclosure provides an apparatus for transmission and reception of a signal, applicable to a network device, such as the network device 101. The apparatus for transmission and reception of a signal is configured to carry out the method for transmission and reception of a signal of the first or second aspect of embodiments.

FIG. 11 is a schematic diagram of the apparatus for transmission and reception of a signal of the fifth aspect of the embodiments of this disclosure. As shown in FIG. 11, an apparatus 1100 for transmission and reception of a first signal may carry out the method for transmission and reception of a signal of the first or second aspect of embodiments. Reference may be made to the description of the method for transmission and reception of a signal of the first and second aspects of embodiments of this disclosure for description of carrying out the method for transmission and reception of a signal by the apparatus 1100 for transmission and reception of a signal.

### Sixth Aspect of Embodiments

The sixth aspect of embodiments of this disclosure provides an apparatus for transmission and reception of a signal, applicable to a terminal equipment, such as the terminal equipment 102. The apparatus for transmission and reception of a signal is configured to carry out the method for transmission and reception of a signal of the third or fourth aspect of embodiments.

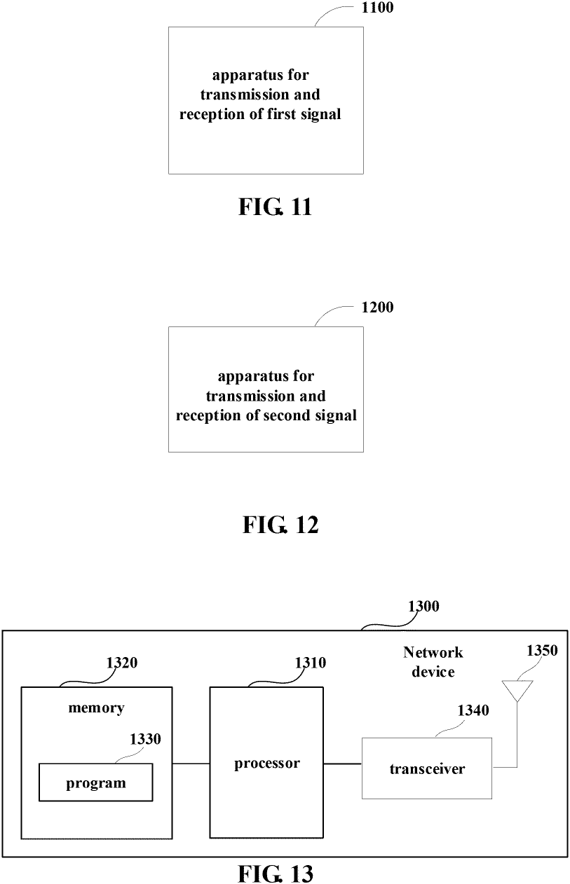

FIG. 12 is a schematic diagram of the apparatus for transmission and reception of a signal of the sixth aspect of the embodiments of this disclosure. As shown in FIG. 12, an apparatus 1200 for transmission and reception of a second signal may carry out the method for transmission and reception of a signal of the third or fourth aspect of embodiments. Reference may be made to the description of the method for transmission and reception of a signal of the third and fourth aspects of embodiments of this disclosure for description of carrying out the method for transmission and reception of a signal by the apparatus 1200 for transmission and reception of a signal.

### Seventh Aspect of Embodiments

The seventh aspect of the embodiments of this disclosure provides a network device, including the apparatus 1100 for transmission and reception of a signal as described in the fifth aspect of the embodiments.

FIG. 13 is a schematic diagram of a structure of the network device of the seventh aspect of the embodiments of this disclosure. As shown in FIG. 13, a network device 1300 may include a processor 1310 and a memory 1320, the memory 1320 being coupled to the processor 1310. The memory 1320 may store various data, and furthermore, it may store a program 1330 for data processing, and execute the program 1330 under control of the processor 1310, so as to receive various information transmitted by a user equipment, and transmit request information to the user equipment.

In one implementation, the functions of the apparatus 1100 for transmission and reception of a signal may be integrated into the processor 1310. The processor 1310 may be configured to carry out the method for transmission and reception of a signal as described in the first or second aspect of the embodiments of this disclosure.

In another implementation, the apparatus 1100 for transmission and reception of a signal and the processor 1310 may be configured separately; for example, the apparatus 1100 for transmission and reception of a signal may be configured as a chip connected to the processor 1310, and the functions of the apparatus 1100 for transmission and reception of a signal are executed under control of the processor 1310.

Furthermore, as shown in FIG. 13, the network device 1300 may include a transceiver 1340, and an antenna 1350, etc. Functions of the above components are similar to those in the related art, and shall not be described herein any further. It should be noted that the network device 1300 does not necessarily include all the parts shown in FIG. 13. Furthermore, the network device 1300 may include parts not shown in FIG. 13, and the related art may be referred to.

### Eighth Aspect of the Embodiments

The eighth aspect of the embodiments of this disclosure provides a terminal equipment, including the apparatus 1200 for transmission and reception of a signal as described in the fifth aspect of the embodiments.

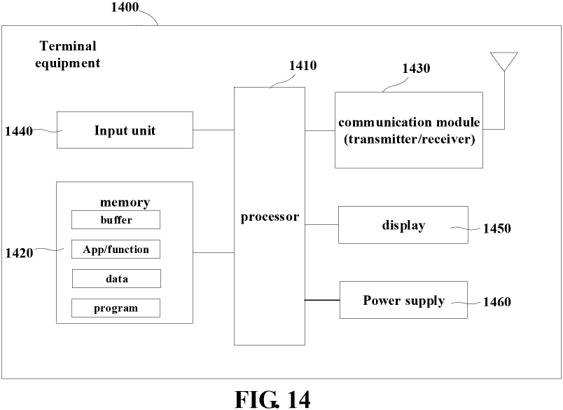

FIG. 14 is a schematic diagram of a systematic structure of the terminal equipment 1400 of the eighth aspect of the embodiments of this disclosure. As shown in FIG. 14, a terminal equipment 1400 may include a processor 1410 and a memory 1402, the memory 1402 being coupled to the processor 1410. It should be noted that this figure is illustrative only, and other types of structures may also be used, so as to supplement or replace this structure and achieve a telecommunications function or other functions.

In one implementation, the functions of the apparatus 1200 for transmission and reception of a signal may be integrated into the processor 1410. The processor 1410 may be configured to carry out the method as described in the third or fourth aspect of the embodiments.

In another implementation, the apparatus 1200 for transmission and reception of a signal and the processor 1410 may be configured separately; for example, the apparatus 1200 for transmission and reception of a signal may be configured as a chip connected to the processor 1410, and the functions of the apparatus 1200 for transmission and reception of a signal are executed under control of the processor 1410.

As shown in FIG. 14, the terminal equipment 1400 may further include a communication module 1430, an input unit 1440, a display 1450, and a power supply 1460. It should be noted that the terminal equipment 1400 does not necessarily include all the parts shown in FIG. 14. Furthermore, the terminal equipment 1400 may include parts not shown in FIG. 14, and the related art may be referred to.

As shown in FIG. 14, the processor 1410 is sometimes referred to as a controller or an operational control, which may include a microprocessor or other processor devices and/or logic devices. The processor 1410 receives input and controls operations of components of the terminal equipment 1400.

The memory 1420 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 1410 may execute programs stored in the memory 1420, so as to realize information storage or processing, etc. Functions of other parts are similar to those of the related art, which shall not be described herein any further. The parts of the terminal equipment 1400 may be realized by specific hardware, firmware, software, or any combination thereof, without departing from the scope of this disclosure.

### Ninth Aspect of the Embodiments

The ninth aspect of the embodiments of this disclosure provides a communication system, including the network device described in seventh aspect of the embodiments and the terminal equipment described in eighth aspect of the embodiments.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

As to implementations including the above embodiments, following supplements are further disclosed.

### A Method at a Network Side

1. A method for transmission and reception of a signal, applicable to a network device, the method for transmission and reception of a signal including:
transmitting first random access configuration information used for an unconventional terminal and second random access configuration information used for a conventional terminal;
receiving a message transmitted by the unconventional terminal according to first random access configuration; and
performing data transmission with the unconventional terminal by using an unconventional transmission mode.

2. The method according to supplement 1, wherein,
the first random access configuration includes at least one of the following configurations:
random access channel (RACH) configuration of a first message (msg 1);
physical uplink shared channel (PUSCH) configuration of a third message (msg 3);
random access channel (RACH) configuration of a second message (Msg A) in two-step random access;
PUSCH configuration of the second message (Msg A);
physical uplink control channel (PUCCH) configuration performing HARQ feedback on a fourth message (msg 4); or
physical uplink control channel (PUCCH) configuration performing HARQ feedback on a fifth message (Msg B).

3. The method according to supplement 2, wherein after the receiving the message transmitted by the unconventional terminal according to the first random access configuration information, the method for transmission and reception of a signal further includes:

identifying the unconventional terminal according to a resource indicated by the first random access configuration.

4. The method according to supplement 2, wherein the unconventional transmission mode includes at least one of the following:

being lower than a bandwidth supported by the conventional terminal, being less than the number of antennas supported by the conventional terminal, being less than the number of HARQ processes supported by the conventional terminal, being lower than a modulation and coding scheme supported by the conventional terminal, a half-duplex frequency-division duplex mode, or being smaller than a transport block size supported by the conventional terminal.

5. The method according to supplement 2, wherein,
the transmitting first random access configuration information used for an unconventional terminal and second random access configuration information used for a conventional terminal includes:
transmitting first system information used for the unconventional terminal and second system information used for the conventional terminal.

6. The method according to supplement 5, wherein,
the first system information includes a first master information block (MIB) and a first system information block 1 (SIB1), the first master information block containing configuration information used for receiving a physical downlink control channel (PDCCH) of the first system information block 1;
and the second system information includes a second master information block and a second system information block 1, the second master information block containing configuration information used for scheduling a PDCCH of the second system information block 1.

7. The method according to supplement 6, wherein,

the first master information block further contains an unconventional identifier used for indicating that the first master information block contains configuration information used for scheduling a physical downlink control channel (PDCCH) of the first system information block 1.

8. The method according to supplement 5, wherein,
the first system information includes a third master information block, a third system information block 1 and a fourth system information block 1 (SIB 1), and the second system information includes the third master information block and the third system information block 1,
wherein the third master information block contains configuration information used for scheduling a PDCCH of the third system information block 1, and the third system information block 1 contains configuration information used for scheduling a PDCCH of the fourth system information block 1,
wherein the fourth system information block 1 contains the first random access configuration information,
and the third system information block 1 contains the second random access configuration information.

9. The method according to supplement 2, wherein,
the transmitting first random access configuration information used for an unconventional terminal and second random access configuration information used for a conventional terminal includes:
transmitting first uplink bandwidth part (BWP) configuration information used for the unconventional terminal and second uplink bandwidth part (BWP) configuration information used for the conventional terminal.

10. The method according to supplement 9, wherein,
the first uplink bandwidth part configuration information includes: first initial uplink bandwidth part configuration information transmitted via system information, wherein the first initial uplink bandwidth part configuration information comprises common configuration of a first initial uplink bandwidth part;
and the second uplink bandwidth part configuration information includes: second initial uplink bandwidth part configuration information transmitted via system information, wherein the second initial uplink bandwidth part configuration information comprises common configuration of a second initial uplink bandwidth part.

11. The method according to supplement 10, wherein,

the first initial uplink bandwidth part or the second initial uplink bandwidth part belongs to a normal uplink (NUL) carrier or a secondary uplink (SUL) carrier of a serving cell.

12. The method according to supplement 10, wherein,
the common configuration of the first initial uplink bandwidth part comprises the random access configuration information used for the unconventional terminal;
and the common configuration of the second initial uplink bandwidth part comprises the random access configuration information used for the conventional terminal.

13. The method according to supplement 9, wherein the second uplink bandwidth part configuration information includes:
at least one piece of second additional uplink bandwidth part configuration information transmitted via dedicated radio resource control (RRC) signaling, wherein,
the second additional uplink bandwidth part configuration information includes a BWP identifier of the second additional uplink bandwidth part, common configuration of the second additional uplink bandwidth part, and/or dedicated configuration of the second additional uplink bandwidth part.

14. The method according to supplement 9, wherein the first uplink bandwidth part configuration information includes:

at least one piece of first additional uplink bandwidth part configuration information transmitted via dedicated radio resource control (RRC) signaling, wherein the first additional uplink bandwidth part configuration information comprises a BWP identifier of the first additional uplink bandwidth part, common configuration of the first additional uplink bandwidth part, and/or dedicated configuration of the first additional uplink bandwidth part.

15. The method according to supplement 14, wherein the common configuration of the first additional uplink bandwidth part contains the random access configuration information for the unconventional terminal.

16. The method according to supplement 2, wherein,
the first random access configuration information includes first random access configuration information of a third uplink initial bandwidth part transmitted via system information;
and the second random access configuration information includes second random access configuration information of the third uplink initial bandwidth part transmitted via system information.

17. The method according to supplement 16, wherein the third uplink initial bandwidth part belongs to a normal uplink (NUL) carrier or a secondary uplink (SUL) carrier of the serving cell.

18. The method according to supplement 16, wherein,

if a fourth optional parameter is not configured in configuration information of first random access of the third initial uplink bandwidth part, the unconventional terminal applies a corresponding parameter in configuration information of second random access of the third initial uplink bandwidth part.

19. The method according to supplement 2, wherein,
the second random access configuration information includes:
second random access configuration information of at least one third additional uplink bandwidth part transmitted via dedicated radio resource control (RRC) signaling.

20. The method according to supplement 2, wherein,
the first random access configuration information includes:
first random access configuration information of at least one third additional uplink bandwidth part transmitted via dedicated radio resource control (RRC) signaling.

21. The method according to supplement 16 or 19 or 20, wherein,
the first random access and the second random access share a random access occasion (RO); or
a random access occasion (RO) of the first random access is independent of a random access occasion (RO) of the second random access.

22. The method according to supplement 21, wherein,
the first random access configuration information further includes:
the number of preambles that are able to be used by the unconventional terminal in the random access occasion (RO).

23. The method according to supplement 2, wherein,
the first random access configuration information includes first uplink grant configuration information transmitted via a random access response (RAR) and used for the unconventional terminal to transmit the third message (msg 3);
and the second random access configuration information includes second uplink grant configuration information transmitted via a random access response (RAR) and used for the conventional terminal to transmit the third message (msg 3).

24. The method according to supplement 2, wherein,
the first random access configuration information includes first physical uplink control channel (PUCCH) configuration information transmitted via a random access response (RAR) and used for performing HARQ feedback on the fourth message (msg 4);
and the second random access configuration information includes second physical uplink control channel (PUCCH) configuration information transmitted via a random access response (RAR) and used for performing HARQ feedback on the fourth message (msg 4).

25. The method according to supplement 2, wherein,
the first random access configuration information includes third physical uplink control channel (PUCCH) configuration information transmitted via a fallback random access response (fallbackRAR) and used for performing HARQ feedback on the fourth message (msg 4);
and the second random access configuration information includes fourth physical uplink control channel (PUCCH) configuration information transmitted via a fallback random access response (fallbackRAR) and used for performing HARQ feedback on the fourth message (msg 4).

26. The method according to supplement 2, wherein,
the first random access configuration information includes fifth physical uplink control channel (PUCCH) configuration information transmitted via a success random access response (successRAR) and used for performing HARQ feedback on the fifth message (Msg B);
and the second random access configuration information includes sixth physical uplink control channel (PUCCH) configuration information transmitted via a success random access response (successRAR) and used for performing HARQ feedback on the fifth message (Msg B).

27. A method for transmission and reception of a signal, applicable to a network device, the method including:
receiving unconventional capability indication information transmitted by an unconventional terminal on a physical uplink shared channel (PUSCH); and
performing data transmission with the unconventional terminal by using an unconventional transmission mode.

28. The method according to supplement 27, wherein after the receiving unconventional capability indication information transmitted by the unconventional terminal, the method further includes:

identifying the unconventional terminal according to the unconventional capability indication information.

29. The method according to supplement 27, wherein the unconventional transmission mode includes at least one of the following:

being lower than a bandwidth supported by the conventional terminal, being less than the number of antennas supported by the conventional terminal, being less than the number of HARQ processes supported by the conventional terminal, being lower than a modulation and coding scheme supported by the conventional terminal, a half-duplex frequency-division duplex mode, or being smaller than a transport block size supported by the conventional terminal.

30. The method according to supplement 27, wherein,
the unconventional capability indication information includes:
an unconventional capability indication MAC layer control unit.

31. The method according to supplement 30, wherein,
the physical uplink shared channel (PUSCH) includes:
a PUSCH of a third message (msg 3), or a PUSCH of a second message (Msg A), of random access.

32. The method according to supplement 27, wherein,
the unconventional capability indication information includes:
an unconventional C-RNTI used for scrambling the uplink shared channel (PUSCH), or an MAC layer control element (CE) containing an unconventional C-RNTI and transmitted via the physical uplink shared channel (PUSCH).

33. The method according to supplement 32, wherein the physical uplink shared channel (PUSCH) includes a PUSCH of the third message (msg 3), or a PUSCH of the second message (Msg A), of the random access.

34. The method according to supplement 32, wherein before the receiving unconventional capability indication information transmitted by an unconventional terminal on a physical uplink shared channel (PUSCH), the method further includes:

configuring the unconventional C-RNTI for the unconventional terminal, wherein the unconventional C-RNTI is different from a C-RNTI of a conventional terminal.

35. The method according to supplement 34, wherein the configuring the unconventional C-RNTI for the unconventional terminal includes:
transmitting the unconventional C-RNTI to the unconventional terminal via a random access response (RAR) or a fallback random access response (fallbackRAR); or
transmitting the unconventional C-RNTI to the unconventional terminal via a success random access response (successRAR).

### A Method at a Terminal Side

1. A method for transmission and reception of a signal, applicable to a terminal equipment, the method including:
receiving first random access configuration information used for an unconventional terminal transmitted by a network device;
transmitting a message to the network device according to first random access configuration; and
performing data transmission with the network device by using an unconventional transmission mode.

2. The method according to supplement 1, wherein,
the first random access configuration includes at least one of the following configurations:
random access channel (RACH) configuration of a first message (msg 1);
physical uplink shared channel (PUSCH) configuration of a third message (msg 3);
random access channel (RACH) configuration of a second message (Msg A) in two-step random access;
PUSCH configuration of the second message (Msg A);
physical uplink control channel (PUCCH) configuration performing HARQ feedback on a fourth message (msg 4); or
physical uplink control channel (PUCCH) configuration performing HARQ feedback on a fifth message (Msg B).

3. The method according to supplement 2, wherein the unconventional transmission mode includes at least one of the following:

being lower than a bandwidth supported by the conventional terminal, being less than the number of antennas supported by the conventional terminal, being less than the number of HARQ processes supported by the conventional terminal, being lower than a modulation and coding scheme supported by the conventional terminal, a half-duplex frequency-division duplex mode, or being smaller than a transport block size supported by the conventional terminal.

4. The method according to supplement 3, wherein, before the performing data transmission with the network device by using an unconventional transmission mode, the method further includes:

receiving configuration information on the unconventional transmission mode of the network device.

5. The method according to supplement 2, wherein,
the receiving first random access configuration information used for an unconventional terminal includes:
receiving first system information used for the unconventional terminal.

6. The method according to supplement 5, wherein,
the first system information includes a first master information block (MIB) and a first system information block 1 (SIB1), the first master information block containing configuration information used for scheduling a physical downlink control channel (PDCCH) of the first system information block 1;
wherein the first system information block 1 includes the first random access configuration information used for the unconventional terminal.

7. The method according to supplement 5, wherein the method further includes:
receiving second system information used for the conventional terminal,
the second system information including a second master information block and a second system information block 1, the second master information block containing configuration information used for scheduling a PDCCH of the second system information block 1.

8. The method according to supplement 7, wherein the second system information block 1 contains second random access configuration information used for the conventional terminal.

9. The method according to supplement 6, wherein,

the first master information block further contains an unconventional identifier used for indicating that the first master information block contains the configuration information used for receiving the physical downlink control channel (PDCCH) of the first system information block 1.

10. The method according to supplement 5, wherein,
the first system information includes a third master information block, a third system information block 1 and a fourth system information block 1 (SIB1);
wherein the third master information block contains configuration information used for scheduling a PDCCH of the third system information block 1, the third system information block 1 containing configuration information used for scheduling a PDCCH of the fourth system information block 1;
and wherein the fourth system information block 1 contains the first random access configuration information.

11. The method according to supplement 10, wherein the third system information block 1 further includes second random access configuration information used for a conventional terminal.

12. The method according to supplement 2, wherein,
the receiving first random access configuration information used for an unconventional terminal includes:
receiving first uplink bandwidth part (BWP) configuration information used for the unconventional terminal.

13. The method according to supplement 12, wherein,

the first uplink bandwidth part configuration information includes first initial uplink bandwidth part configuration information received via system information, wherein the first initial uplink bandwidth part configuration information includes common configuration of a first initial uplink bandwidth part.

14. The method according to supplement 13, wherein,

the first initial uplink bandwidth part belongs to a normal uplink (NUL) carrier or a secondary uplink (SUL) carrier, of a serving cell.

15. The method according to supplement 13, wherein the method further includes:
receiving second uplink bandwidth part (BWP) configuration information used for a conventional terminal,
the second uplink bandwidth part configuration information including second initial uplink bandwidth part configuration information received via system information,
wherein, the second initial uplink bandwidth part configuration information includes common configuration of a second initial uplink bandwidth part.

16. The method according to supplement 15, wherein,

if a first optional parameter is not configured in common configuration of the first initial uplink bandwidth part, the terminal applies a corresponding parameter in common configuration of the second initial uplink bandwidth part.

17. The method according to supplement 13, wherein,

the common configuration of the first initial uplink bandwidth part contains the first random access configuration information.

18. The method according to supplement 12, wherein the first uplink bandwidth part configuration information includes:

at least one piece of first additional uplink bandwidth part configuration information transmitted via dedicated radio resource control (RRC) signaling, wherein the first additional uplink bandwidth part configuration information includes a BWP identifier of the first additional uplink bandwidth part, common configuration of the first additional uplink bandwidth part, and/or dedicated configuration of the first additional uplink bandwidth part.

19. The method according to supplement 18, wherein the method further includes:
receiving third uplink bandwidth part (BWP) configuration information used for the conventional terminal;
the third uplink bandwidth part configuration information including:
at least one piece of second additional uplink bandwidth part configuration information received via dedicated radio resource control (RRC) signaling,
wherein the second additional uplink bandwidth part configuration information includes a BWP identifier of the second additional uplink bandwidth part, common configuration of the second additional uplink bandwidth part, and/or dedicated configuration of the second additional uplink bandwidth part.

20. The method according to supplement 19, wherein,
if a second optional parameter is not configured in common configuration of the first initial uplink bandwidth part, the terminal applies a corresponding parameter in common configuration of the second initial uplink bandwidth part; or,
if a third optional parameter is not configured in common configuration of the first initial uplink bandwidth part, the terminal applies a corresponding parameter in common configuration of the second initial uplink bandwidth part.

21. The method according to supplement 18, wherein the common configuration of the first additional uplink bandwidth part contains the first random access configuration information.

22. The method according to supplement 2, wherein,

the first random access configuration information includes first random access configuration information of a third initial uplink bandwidth part received via system information.

23. The method according to supplement 22, wherein the third uplink initial bandwidth part belongs to a normal uplink (NUL) carrier or a secondary uplink (SUL) carrier, of the serving cell.

24. The method according to supplement 22, wherein the method further includes:

receiving third random access configuration information used for a conventional terminal, the third random access configuration information including third random access configuration information of the third uplink initial bandwidth part received via the system information.

25. The method according to supplement 24, wherein,

if a fourth optional parameter is not configured in random access configuration information of the third initial uplink bandwidth part, the terminal applies a corresponding parameter in the random access configuration information on the third initial uplink bandwidth part.

26. The method according to supplement 24 or 25, wherein the first random access and the third random access share a random access occasion (RO); or,

a random access occasion (RO) of the first random access is independent of a random access occasion (RO) of the third random access.

27. The method according to supplement 2, wherein,
the first random access configuration information includes:
first random access configuration information on at least one third additional uplink bandwidth part received via dedicated radio resource control (RRC) signaling.

28. The method according to supplement 27, wherein the method further includes:

receiving fourth random access configuration information used for a conventional terminal, the fourth random access configuration information comprising fourth random access configuration information of at least one third uplink initial bandwidth part received via dedicated radio resource control (RRC) signaling.

29. The method according to supplement 27, wherein,

if a fifth optional parameter is not configured in first random access configuration information of the third initial uplink bandwidth part, the terminal applies a corresponding parameter in fourth random access configuration information of the third initial uplink bandwidth part.

30. The method according to supplement 28 or 29, wherein,
the first random access and the fourth random access share a random access occasion (RO); or,
a random access occasion (RO) of the first random access is independent of a random access occasion (RO) of the fourth random access.

31. The method according to supplement 26 or 30, wherein,
the first random access configuration information includes:
the number of preambles that are able to be used by the unconventional terminal in the random access occasion (RO).

32. The method according to supplement 2, wherein,

the first random access configuration information includes first uplink grant configuration information received via a random access response (RAR) and used for transmitting the third message (msg 3).

33. The method according to supplement 32, wherein the random access response further carries second uplink grant configuration information used for transmitting the third message (msg 3) by the conventional terminal.

34. The method according to supplement 32, wherein the method further includes:
processing the received first uplink grant configuration information, and indicating the first uplink grant to a physical layer, by an MAC layer of the terminal; and
transmitting the third message (msg 3) by the physical layer by using the first uplink grant.

35. The method according to supplement 2, wherein,

the first random access configuration information includes first physical uplink control channel (PUCCH) configuration information received via a random access response (RAR) and used for performing HARQ feedback on the fourth message (msg 4).

36. The method according to supplement 35, wherein the random access response (RAR) also carries second physical uplink control channel (PUCCH) configuration information used for performing HARQ feedback on the fourth message (msg 4) by the conventional terminal.

37. The method according to supplement 35, wherein the method further includes:
instructing the physical layer to generate HARQ feedback by the MAC layer after the terminal is successful in random access; and
performing HARQ feedback on the fourth message by the physical layer by using the physical uplink control channel (PUCCH) configured by the first physical uplink control channel (PUCCH) configuration information.

38. The method according to supplement 2, wherein,

the first random access configuration information includes third physical uplink control channel (PUCCH) configuration information received via a fallback random access response (fallbackRAR) and used for performing HARQ feedback on the fourth message (msg 4).

39. The method according to supplement 38, wherein,

the fallback random access response (fallbackRAR) also carries fourth physical uplink control channel (PUCCH) configuration information used for performing HARQ feedback on the fourth message (msg 4) by the conventional terminal.

40. The method according to supplement 38, wherein the method further includes:
instructing the physical layer to generate HARQ feedback by the MAC layer after the terminal is successful in random access; and
performing HARQ feedback on the fourth message by the physical layer by using the physical uplink control channel (PUCCH) configured by the third physical uplink control channel (PUCCH) configuration information.

41. The method according to supplement 2, wherein,

the first random access configuration information includes fifth physical uplink control channel (PUCCH) configuration information received via a success random access response (successRAR) and used for performing HARQ feedback on the fifth message (msg B).

42. The method according to supplement 41, wherein,

the success random access response (successRAR) also carries sixth physical uplink control channel (PUCCH) configuration information used for performing HARQ feedback on the fifth message (msg B) by the conventional terminal.

43. The method according to supplement 41, wherein the method further includes:
instructing the physical layer to generate HARQ feedback by the MAC layer after the terminal is successful in random access; and
performing HARQ feedback on the fifth message by the physical layer by using a physical uplink control channel (PUCCH) configured by the fifth physical uplink control channel (PUCCH) configuration information.

44. A method for transmission and reception of a signal, applicable to a terminal equipment, the method including:
transmitting unconventional capability indication information to a network device via a physical uplink shared channel (PUSCH); and
performing data transmission with the network device by using an unconventional transmission mode.

45. The method according to supplement 44, wherein,
the unconventional transmission mode comprises at least one of the following:
being lower than a bandwidth supported by the conventional terminal, being less than the number of antennas supported by the conventional terminal, being less than the number of HARQ processes supported by the conventional terminal, being lower than a modulation and coding scheme supported by the conventional terminal, a half-duplex frequency-division duplex mode, or being smaller than a transport block size supported by the conventional terminal.

46. The method according to supplement 44, wherein the method further includes:

receiving configuration information on the unconventional transmission mode of the network device.

47. The method according to supplement 44, wherein,
the unconventional capability indication information includes:
an unconventional capability indication MAC layer control unit transmitted via a physical uplink shared channel (PUSCH).

48. The method according to supplement 47, wherein,

the physical uplink shared channel (PUSCH) includes a PUSCH of a third message (msg 3), or a PUSCH of a second message (Msg A), of random access.

49. The method according to supplement 44, wherein,
the unconventional capability indication information includes:
an unconventional C-RNTI used for scrambling the uplink shared channel (PUSCH), or an MAC layer control element (CE) containing an unconventional C-RNTI and transmitted via the physical uplink shared channel (PUSCH).

50. The method according to supplement 49, wherein the physical uplink shared channel (PUSCH) includes a PUSCH of a third message (msg 3), or a PUSCH of a second message (Msg A), of random access.

51. The method according to supplement 49, wherein,
before the transmitting unconventional capability indication information, the method further includes:
receiving the unconventional C-RNTI configured by the network device for the unconventional terminal, wherein the unconventional C-RNTI is different from a C-RNTI of a conventional terminal.

52. The method according to supplement 51, wherein the receiving the unconventional C-RNTI configured by the network device for the unconventional terminal includes:
receiving the unconventional C-RNTI via a random access response (RAR) or a fallback random access response (fallbackRAR); or,
receiving the unconventional C-RNTI via a success random access response (successRAR).

1. An apparatus for transmission and reception of a signal, applicable to a network device, the apparatus comprising:
a transmitter configured to:
transmit a first initial uplink bandwidth part (BWP) configuration used for a reduced capability terminal and a second initial uplink bandwidth part (BWP) configuration used for a terminal, or
transmit a third initial uplink BWP configuration shared by the reduced capability terminal and the terminal; wherein a first random access configuration used for the reduced capability terminal is included in the first initial uplink BWP configuration and the third initial uplink BWP configuration;
a receiver configured to receive a message transmitted by the reduced capability terminal according to the first random access configuration; and
a processor configured to perform data transmission with the reduced capability terminal by using an reduced capability transmission mode.

2. The apparatus according to claim 1, wherein,
the first random access configuration comprises at least one of the following configurations:
random access channel (RACH) configuration of a first message (msg 1);
physical uplink shared channel (PUSCH) configuration of a third message (msg 3);
random access channel (RACH) configuration of a second message (Msg A) of two-step random access;
PUSCH configuration of the second message (Msg A);
physical uplink control channel (PUCCH) configuration performing HARQ feedback on a fourth message (msg 4); and
physical uplink control channel (PUCCH) configuration performing HARQ feedback on a fifth message (Msg B).

3. The apparatus according to claim 2, wherein the reduced capability transmission mode comprises at least one of the following:
being lower than a bandwidth supported by the terminal, being less than the number of antennas supported by the terminal, being less than the number of HARQ processes supported by the terminal, being lower than a modulation and coding scheme supported by the terminal, a half-duplex frequency-division duplex mode, being smaller than a transport block size supported by the terminal.

4. The apparatus according to claim 2, wherein the processor is further configured to identify the reduced capability terminal according to a resource indicated by the first random access configuration.

5. The apparatus according to claim 2, wherein
a second random access configuration for the capability terminal is included in the second initial uplink BWP configuration and the third initial uplink BWP.

6. The apparatus according to claim 5, wherein,
the first random access and the second random access share a random access opportunity (RO); or
a random access opportunity (RO) of the first random access is independent of a random access opportunity (RO) of the second random access.

7. The apparatus according to claim 6, wherein,
the first random access configuration further includes the number of preambles that are able to be used by the reduced capability terminal in the random access opportunity (RO).

8. An apparatus for transmission and reception of a signal, applicable to a reduced capability terminal equipment, the apparatus comprising:
a receiver configured to:
receive a first initial uplink bandwidth part (BWP) configuration used for the reduced capability terminal; or
receive a third initial uplink BWP configuration shared by the reduced capability terminal and a terminal; wherein a first random access configuration used for the reduced capability terminal is included in the first initial uplink BWP configuration and the third initial uplink BWP configuration;
a transmitter configured to message a message to the network device according to the first random access configuration information; and
a processor configured to perform data transmission with the network device by using a reduced capability transmission mode.

9. The apparatus according to claim 8, wherein,
the first random access configuration comprises at least one of the following configurations:
random access channel (RACH) configuration of a first message (msg 1);
physical uplink shared channel (PUSCH) configuration of a third message (msg 3);
random access channel (RACH) configuration of a second message (Msg A) of two-step random access;
PUSCH configuration of the second message (Msg A);
physical uplink control channel (PUCCH) configuration performing HARQ feedback on a fourth message (msg 4); and
physical uplink control channel (PUCCH) configuration performing HARQ feedback on a fifth message (Msg B).

10. The apparatus according to claim 9, wherein,
a second random access configuration for the terminal is included in a second initial uplink BWP configuration and the third initial uplink BWP, the second initial uplink BWP configuration being used for a terminal.

11. The apparatus according to claim 10, wherein,
the first random access and the second random access share a random access opportunity (RO); or
a random access opportunity (RO) of the first random access is independent of a random access opportunity (RO) of the second random access.

12. The apparatus according to claim 11, wherein, the first random access configuration comprises:
the number of preambles that are able to be used by the reduced capability terminal in the random access opportunity (RO).

13. A method for transmission and reception of a signal, applicable to a network device, the method comprising:
receiving reduced capability indication information transmitted by a reduced capability terminal on a physical uplink shared channel (PUSCH); and
performing data transmission with the reduced capability terminal by using an reduced capability transmission mode.

14. The method according to claim 13, further comprising:
identifying the reduced capability terminal according to the reduced capability indication information after receiving reduced capability indication information transmitted by the reduced capability terminal.

15. The method according to claim 14, wherein, the physical uplink shared channel (PUSCH) includes a PUSCH of a third message (msg 3), or a PUSCH of a second message (Msg A), of random access.

16. An apparatus for transmission and reception of a signal, applicable to a terminal equipment, the apparatus comprising:
a transmitter configured to transmit reduced capability indication information to a network device via a physical uplink shared channel (PUSCH); and
a processor configured to perform data transmission with the network device by using an reduced capability transmission mode.

17. The apparatus according to claim 16, wherein,
the reduced capability transmission mode comprises at least one of the following:
being lower than a bandwidth supported by a terminal, being less than the number of antennas supported by the terminal, being less than the number of HARQ processes supported by the terminal, being lower than a modulation and coding scheme supported by the terminal, a half-duplex frequency-division duplex mode, being smaller than a transport block size supported by the terminal.

18. The apparatus according to claim 16, wherein, the reduced capability indication information includes an reduced capability indication MAC layer control element transmitted via the physical uplink shared channel (PUSCH).
